(19) United States
(12) Patent Application Publication
(10) Pub. No.: US 2015/0365037 A1
(43) Pub. Date: Dec. 17, 2015

(54) ALTERNATING CURRENT MOTOR DRIVE SYSTEM

(71) Applicants: Kazuyoshi WATABU, Chiyoda-ku (JP); Akiko TABUCHI, Chiyoda-ku (JP); Yoshinori KANDA, Chiyoda-ku (JP); Tetsuya OKUDA, Chiyoda-ku (JP)

(72) Inventors: Kazuyoshi WATABU, Chiyoda-ku (JP); Akiko TABUCHI, Chiyoda-ku (JP); Yoshinori KANDA, Chiyoda-ku (JP); Tetsuya OKUDA, Chiyoda-ku (JP)

(73) Assignee: MITSUBISHI ELECTRIC CORPORATION, Chiyoda-ku, Tokyo (JP)

(21) Appl. No.: 14/237,630

(22) PCT Filed: Mar. 7, 2013
(86) PCT No.: PCT/JP2013/001447

§ 371 Date: Feb. 7, 2014

(51) Int. Cl. H02P 27/06

(52) U.S. Cl. CPC H02P 27/06

(57) ABSTRACT

An alternating current (AC) motor drive system is provided in which electric power can be supplied between a direct current (DC) bus and an electric power storage device, using a voltage value across a DC bus, without providing means that measures an amount of current flowing through the DC bus. In the AC motor drive system of the invention, according to a voltage value measured by DC voltage value detection means and a charge/discharge current amount measured by charge/discharge current amount detection means, a charge/discharge circuit causes an electric power storage device to discharge an amount of electric power, from among amounts of electric power supplied from an inverter to an AC motor, that exceeds a first electric power threshold value, or the circuit causes the electric storage device to store an amount of electric power, from among amounts of AC motor regenerative electric power regenerated via the inverter, that exceeds a second electric power threshold value.

### TECHNICAL FIELD

The present invention relates to an alternating current (AC) motor drive system that suppresses peak electric power of the AC motor drive system by employing energy, stored in an electric power storage device, during motoring operation of the AC motor, or by storing energy in the storage device during regenerative operation of the AC motor.

### BACKGROUND ART

In a conventional AC motor drive system, direct current (DC) electric power, generated from a DC electric power supply, is provided via a DC bus to an inverter, which in turn provides proper AC electric power to an AC motor by DC-AC electric power conversion. An electric power compensation device, which is connected, in parallel with an inverter, to the DC bus that electrically couples the DC electric power supply with the inverter, is configured by devices such as a step-up/down circuit, electric power accumulator, control device, and detectors for voltage and current. And the control device issues a switching command for control of the step-up/down circuit, in response to information of voltage and current values of the DC bus, and of those of the electric power accumulator, derived from each of the detectors, and then discharges electric power of the accumulator toward the DC bus, or charges the accumulator (refer to Patent Document 1).

Another conventional AC motor drive system includes a rectification circuit that converts AC electric power from an AC electric power supply into DC electric power; a smoothing capacitor that smoothes a DC voltage from the rectification circuit; a PWM inverter circuit that converts the DC electric power delivered via the smoothing capacitor into electric power of an arbitrary frequency; a current detector that measures output current generated from inverter; a voltage detection circuit that measures voltage across terminals of the smoothing capacitor; a speed command calculation circuit that calculates a speed command value during detection of an electric power outage; an electric power outage detection circuit that detects the electric power outage and issues, during the power outage, the speed command value by changing from the command during normal operation to that during detection of the power outage; an output voltage command calculation circuit that calculates an output voltage command value, based on the speed command value issued from the electric power outage detection circuit; a PWM control circuit that provides PWM control of a PWM inverter circuit, based on an output signal issued from the electric power outage circuit; a base drive circuit that drives the PWM inverter circuit, in response to an output signal from the PWM control circuit; and an AC motor that is driven by an electric power output from the PWM inverter circuit.

In the other conventional AC motor drive system, when the power outage of the AC electric power supply momentarily occurs, the speed command during the power outage is selected, and the speed command value is calculated based on target and measured voltages across the terminals of the smoothing capacitor. And when the momentary power outage of the AC electric power supply restores, the speed command for the power outage is changed to that for normal operation, thus performing the normal operation. In the other conventional AC motor drive system, a technique is disclosed in which the voltage across the smoothing capacitor terminals is used to continue the system operation during the momentary power outage (refer to Patent Document 2).

### RELATED TECHNICAL DOCUMENT

### Patent Document

Patent Document 1 WO2012-032589 (For example, paragraphs 0017 and 0022, and FIG. 1)

Patent Document 2 JP-4831527 (For example, paragraphs 0011 through 0018, and FIG. 1)

### SUMMARY OF THE INVENTION

### Problems that the Invention is to Solve

In the technique of Patent Document 1, both of means (detectors) are provided which each measure a DC bus voltage value (a voltage across terminals of a smoothing capacitor) and its current amount in order to issue a command for controlling a charge/discharge circuit (step-up/down circuit) and thereby discharge electric power, stored in an electric power storage device (electric power accumulator), toward a DC bus, or charge the storage device with electric power from the DC bus. However, because a large amount of current flows through the DC bus, means that measures an amount of current of the DC bus is expensive as compared to means that detects a voltage value of the DC bus. Moreover, because the means that measures the DC bus current amount is large in volume, a high cost is involved when the means is installed within the device.

In contrast, in the technique of Patent Document 2, no means is provided which measures a DC bus current amount, and during momentary power outage, energy that is stored within a smoothing capacitor is regulated using a DC bus voltage value. However, in order to continue the system operation during the momentary power outage, a deceleration operation needs to be performed. Thus, a problem has been that AC motors cannot perform a desirable operation.

The present invention is directed to overcome the above problems, and an object of the invention is to provide an AC motor drive system in which electric power can be supplied from a DC bus to an electric power storage device and vice versa, using a voltage value of the DC bus, without providing means that measures an amount of current flowing through the DC bus, and in which electric power that is to be supplied to or regenerated from the DC bus can be reduced to or retained at a predetermined value, respectively.

### Means for Solving the Problems

An AC motor drive system according to this invention comprises a converter that supplies DC electric power; an inverter that converts the DC electric power to AC electric power; a DC bus that connects between the converter and the inverter; an AC motor that is driven by the AC electric power; DC voltage value detection means that measures a voltage value at an output side of the converter; an electric power storage device to which the DC electric power is charged from the DC bus and from which the charged DC electric power is discharged to the DC bus; a charge/discharge circuit connected to the DC bus in parallel with the inverter, and connected between the DC bus and the electric power storage device, the charge/discharge circuit causing the electric power storage device to be charged or discharged; and charge/discharge current amount detection means that measures an amount of charge/discharge current of the electric power storage device, wherein according to the DC voltage value measured by the DC voltage value detection means and to the charge/discharge current amount measured by the charge/discharge current amount detection means, the charge/discharge circuit causes the electric power storage device to discharge an amount of electric power, from among amounts of electric power supplied from the inverter to the AC motor, that exceeds a first electric power threshold value, or the circuit causes the electric power storage device to be charged by an amount of electric power, from among amounts of AC motor regenerative electric power regenerated via the inverter, that exceeds a second electric power threshold value.

### Advantageous Effects

According to the present invention, electric power can be supplied between a DC bus and an electric power storage device, using a voltage value of the DC bus, without providing means that measures an amount of current flowing through the DC bus, and electric power that is to be supplied to or regenerated from the DC bus can be reduced to or retained at a predetermined value, respectively.

### BRIEF DESCRIPTION OF DRAWINGS

FIG. 1 is an overall block diagram of an AC motor drive system according to Embodiment 1;

FIG. 2 is a block diagram of a regenerated power dissipating resistor type converter, which is an example of a converter according to Embodiment 1;

FIG. 3 is a block diagram of a converter of a type that returns regenerated power to an electric power supply, which is another example of the converter according to Embodiment 1;

FIG. 4 is a block diagram of a charge/discharge circuit employing a current reversible chopper circuit, which is an example of a charge/discharge circuit according to Embodiment 1;

FIG. 5 is a block diagram of a charge/discharge circuit employing a current reversible step-up/down chopper circuit, which is another example of the charge/discharge circuit according to Embodiment 1;

FIG. 6 is a schematic graph of electric power consumption of an AC motor according to Embodiment 1;

FIG. 7 is a block diagram of charge/discharge control means according to Embodiment 1;

FIG. 8 is a set of time transition diagrams illustrating behaviors of AC motor electric power consumption and a DC bus voltage value during motoring operation, according to Embodiment 1;

FIG. 9 is a schematic graph illustrating a DC bus voltage drop to AC motor electric power consumption during the motoring operation, according to Embodiment 1;

FIG. 10 is a block diagram of a motoring mode control unit according to Embodiment 1;

FIG. 11 is a set of time elapse graphs illustrating behaviors of AC motor electric power consumption and a DC bus voltage value during regenerative operation, according to Embodiment 1;

FIG. 12 is a schematic graph illustrating a voltage rise of a DC bus to AC motor electric power consumption during regenerative operation, according to Embodiment 1;

FIG. 13 is a block diagram of a regenerative mode control unit according to Embodiment 1;

FIG. 14 is a set of schematic graphs illustrating relationships between an electric power supply condition and each of discharge current command value, charge current command value and combined current command value, according to Embodiment 1;

FIG. 15 is a block diagram of a motoring mode control unit according to Embodiment 2;

FIG. 16 is a block diagram of a regenerative mode control unit according to Embodiment 2;

FIG. 17 is a block diagram of another regenerative mode control unit according to Embodiment 2;

FIG. 18 is an overall block diagram of an AC motor drive system according to Embodiment 3;

FIG. 19 is a block diagram of charge/discharge control means according to Embodiment 3;

FIG. 20 is another block diagram of the charge/discharge control means according to Embodiment 3;

FIG. 21 is a block diagram of the charge/discharge control means having an electric power storage regulation technique incorporated, according to Embodiment 3;

FIG. 22 is an overall block diagram of an AC motor drive system according to Embodiment 4;

FIG. 23 shows schematic graphs each illustrating a voltage drop of a DC bus to AC motor electric power consumption during motoring operation, according to Embodiment 4;

FIG. 24 is a block diagram illustrating a motoring mode control unit according to Embodiment 4;

FIG. 25 shows schematic graphs each illustrating a DC bus voltage rise to AC motor electric power consumption during regenerative operation, according to Embodiment 4;

FIG. 26 is a block diagram of a regenerative mode control unit according to Embodiment 4;

FIG. 27 is a time transition diagram during motoring operation, which illustrates behaviors of AC motor electric power consumption, electric power that is supplied by an electric power storage device, and a DC bus voltage value, according to Embodiment 5; and

FIG. 28 is a block diagram of a motoring mode control unit according to Embodiment 5.

### MODES FOR CARRYING OUT THE INVENTION

### Embodiment 1

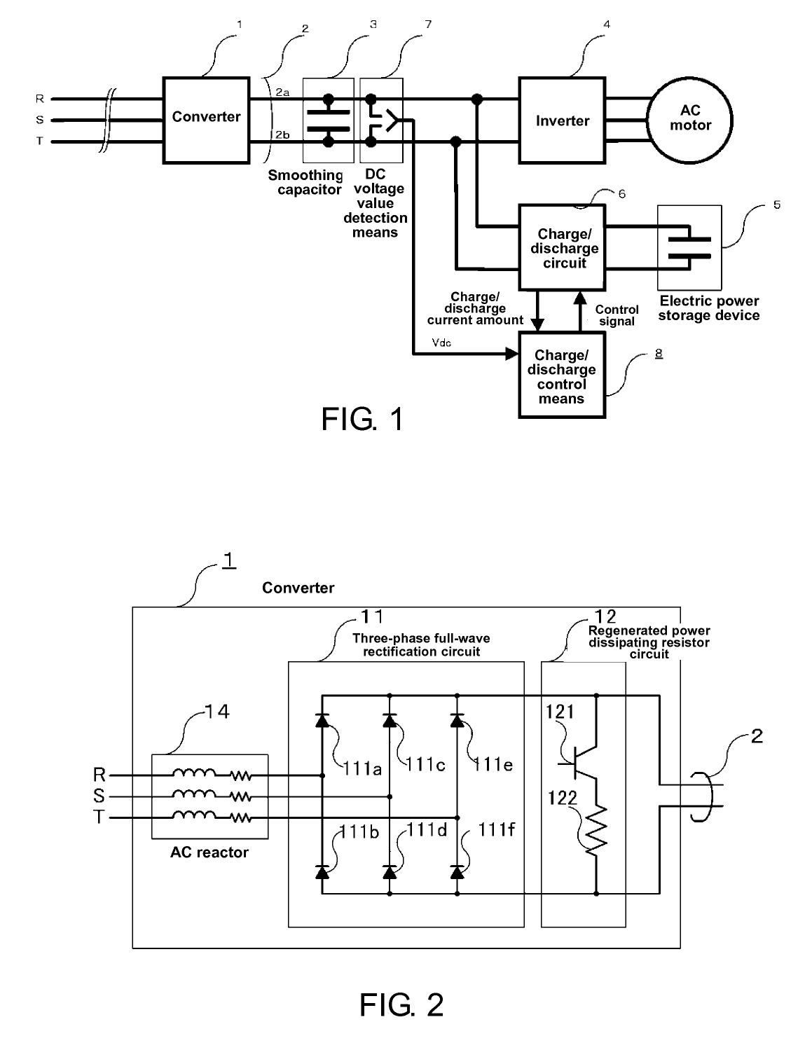

FIG. 1 is an overall block diagram of an AC motor drive system according to Embodiment 1 of the present invention. In the AC motor drive system shown in FIG. 1, from an AC electric power source (not shown), such as an electric power plant or in-factory electric power substation, AC electric power is provided via wiring R, S and T. A converter 1 converts this AC electric power into DC electric power. The DC electric power converted is delivered from the converter 1 to a DC bus 2.

Employed for the converter 1 are, for example, a regenerated power dissipating resistor type converter and a converter of a type that returns regenerated electric power to an electric power supply.

The regenerated power dissipating resistor type converter is configured as shown in FIG. 2. A three-phase full-wave rectification circuit 11 is configured by diodes 111a, 111b, 111c, 111d, 111e and 111f. A regenerated power dissipating resistor circuit 12, which is located toward an output of the three-phase full-wave rectification circuit 11, is configured by a switching element 121 and a resistor 122. When regenerated electric power from the DC bus 2 causes a DC bus 2 voltage value to become higher than a predetermined value, a control unit, not shown, controls the switching element 121 so that it become conductive, and the resistor 122 dissipates the above regenerated electric power. An AC reactor 14 avoids a short circuit(s) between the wiring R, S and T and the DC bus 2.

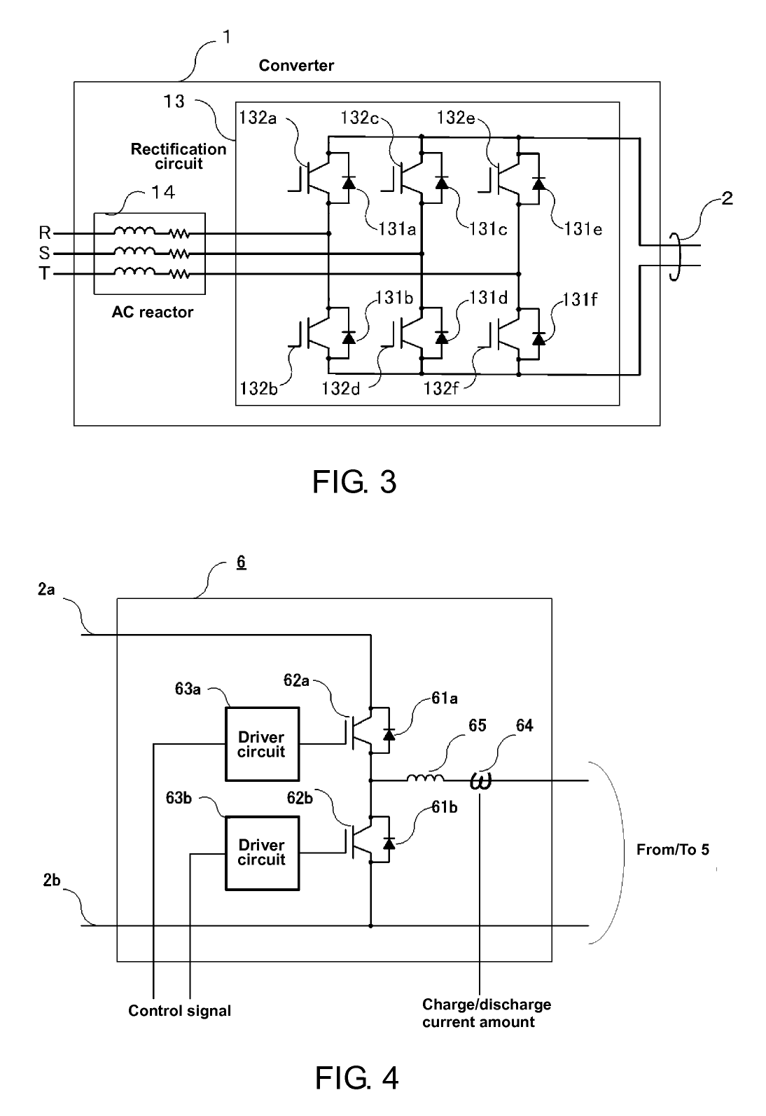

The converter of the type that returns regenerated power to an electric power supply is configured as shown in FIG. 3. A rectification circuit 13 has diodes 131a, 131b, 131c, 131d, 131e and 131f, respectively, which are the same as those of the three-phase full-wave rectification circuit. And the rectification circuit 13 has switching elements 132a, 132b, 132c, 132d, 132e and 132f, such as IGBT, connected in inverse parallel with the above diodes, respectively.

For the purpose of smoothing DC electric power, capacitors are disposed between a high potential side 2a and a low potential side 2b of the DC bus 2, at one or more places in terms of a portion at the output of the converter 1, a portion within the above DC bus 2, a portion at the input of an inverter 4 as will be described later, or a portion located toward the above DC bus 2 of a charge/discharge circuit 6 as will be described later. These capacitors are collectively treated as a smoothing capacitor 3, as shown in FIG. 1. For descriptions to follow, the above smoothing capacitor 3 is assumed to have a capacitance of C [F].

The DC electric power smoothed with the smoothing capacitor 3 is converted to AC electric power by the inverter 4 connected via the DC bus 2 to the converter 1. This AC electric power has a voltage value and frequency different from those of the AC electric power provided from the above AC electric power supply. The AC electric power, which is an output from the above inverter 4, is used to drive an AC motor.

The AC motor drive system according to Embodiment 1 also includes an electric power storage device 5. The electric power storage device 5 stores electric power flowing through the DC bus 2, and discharges the stored electric power to the DC bus 2. The storage device 5 is connected via the charge/discharge circuit 6 to the DC bus 2. The electric power charge/discharge in the storage device 5 is conducted through the charge/discharge circuit 6 connected in parallel with the inverter 4 with respect to the DC bus 2.

Further, DC voltage value detection means 7 is disposed in the AC motor drive system according to Embodiment 1. The DC voltage value detection means 7 measures a voltage value Vdc [V] between the high potential side 2a and the low potential side 2b of the DC bus 2. The voltage value Vdc [V] is delivered from the DC voltage value detection means 7 to charge/discharge control means 8. In response to the voltage value Vdc [V], the charge/discharge control means 8 issues a control signal for controlling the charge/discharge circuit 6.

In general, the charge/discharge circuit 6 employs a current reversible chopper circuit.

The charge/discharge circuit 6 having a current reversible chopper circuit incorporated is shown in FIG. 4 as an example of the charge/discharge circuit 6. The charge/discharge circuit 6 incorporating the current reversible chopper circuit has two diodes 61a, 61b connected in series between the DC bus 2 high and low potential sides 2a, 2b, as shown in FIG. 4. Switching elements 62a, 62b are connected in reverse parallel with the diodes 61a, 61b, respectively. Driver circuits 63a, 63b control the switching elements 62a, 62b, respectively, in accordance with a control signal issued by the charge/discharge control means 8. Connected to a junction of the diode 61a with the diode 61b is one end of a reactor 65, and the other end thereof is connected to one terminal of the storage device 5 via charge/discharge current amount detection means 64 that measures a charge/discharge current amount of the storage device 5. In contrast, the other terminal of the storage device 5 is connected to the DC bus 2 low potential side 2b. A charge/discharge current amount of the storage device 5, measured by the charge/discharge current amount detection means 64, is delivered to the charge/discharge control means 8.

An N multiple current reversible chopper circuit is in some cases employed as another example of the charge/discharge circuit 6, the chopper circuit being one in which N multiple current reversible chopper circuits shown in FIG. 4 are configured between the DC bus 2 high and low potential sides 2a, 2b. When the N multiple current reversible chopper circuit is employed, N reactors' terminals to which no diodes are connected are collectively connected to one terminal of the storage device 5, while the other terminal thereof is connected to the DC bus 2 low potential side 2b. When employing the N multiple current reversible chopper circuit, each of the N reactors is provided with the charge/discharge current amount detection means, and each of the current amounts measured by the respective charge/discharge current amount detection means is delivered as a charge/discharge current amount of the respective phase, to the charge/discharge control means 8.

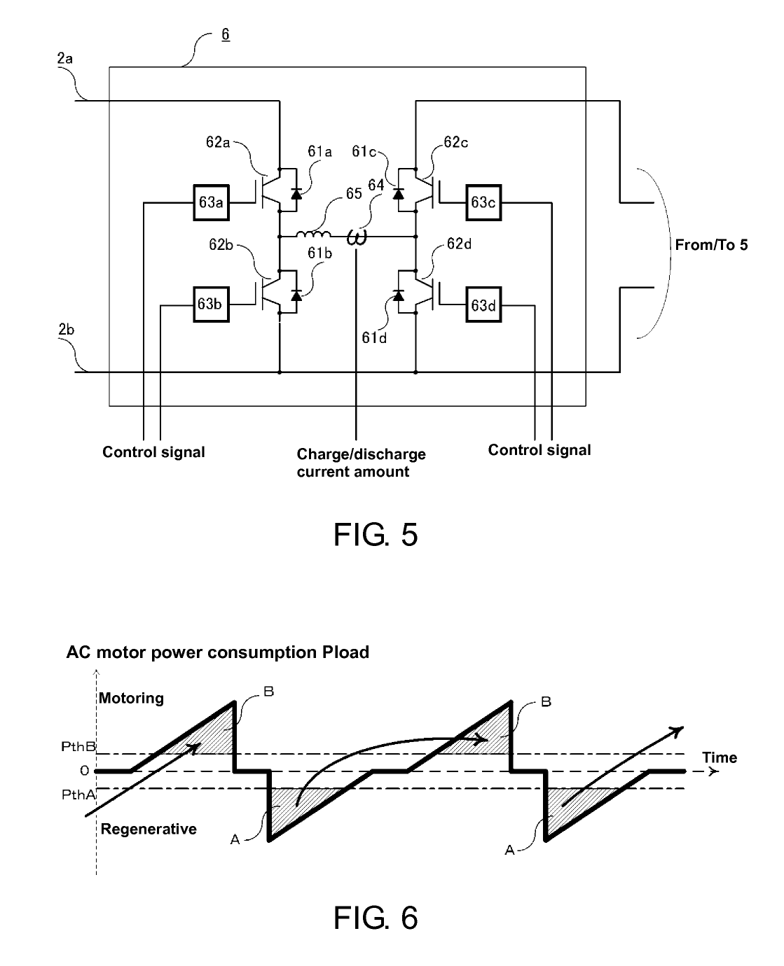

In still another example of the charge/discharge circuit 6, the charge/discharge circuit 6 having a current reversible step-up/down chopper circuit incorporated is shown in FIG. 5. The charge/discharge circuit 6 incorporating the current reversible step-up/down chopper circuit has two diodes 61a, 61b connected in series between the DC bus 2 high and low potential sides 2a, 2b, as shown in FIG. 5. The switching elements 62a, 62b are connected in reverse parallel with the diodes 61a, 61b, respectively. Each of the driver circuits 63a, 63b controls the respective switching elements 62a, 62b in accordance with a control signal issued by the charge/discharge control means 8. Connected to the junction of the diode 61a with the diode 61b is one end of the reactor 65, and the other end thereof is connected, as shown in FIG. 5, to a junction between the other two diodes 61c, 61d, via the charge/discharge current amount detection means 64 that measures a charge/discharge current amount of the storage device 5. The end of the diode 61c, which is not in connection to the charge/discharge current amount diction means 64, is connected to one terminal of the storage device 5. The end of the diode 61d, which is not in connection to the charge/discharge current amount diction means 64, is connected to the DC bus 2 low potential side 2b and further to the other terminal of the storage device 5. The diodes 61c, 61d are connected in reverse parallel with the switching elements 62c, 62d, respectively. Driver circuits 63c, 63d control the switching elements 62c, 62d, respectively, in accordance with a control signal issued by the charge/discharge control means 8. The charge/discharge current amount of the storage device 5, measured by the charge/discharge current amount detection means 64, is delivered to the charge/discharge control means 8.

The charge/discharge circuit 6 can have an N multiple current reversible step-up/down chopper circuit. In this instance, N reactors are each provided with the charge/discharge current amount detection means, and each of the current amounts measured by the respective charge/discharge current amount detection means is delivered as a charge/discharge current amount of the each phase, to the charge/discharge control means 8.

In further descriptions below, the switching elements 62a, 62b, and 62c, 62d are collectively treated as switching elements 62. Further, the driver circuits 63a, 63b, and 63c, 63d are collectively treated as the driver circuits 63.

For a control signal that is issued from the charge/discharge control means 8 to the charge/discharge circuit 6, a pulse width modulation (PWM) signal is employed. The PWM signal switches the switching element in a chopper circuit from an on-state to an off-state and vice versa.

Note that it is obvious that advantageous effects of the present invention is not eliminated even if the connection of the reactor 65 to the charge/discharge current amount detection means 64 is reverse in the charge/discharge circuit 6. Further, the detection means 64 is disposed within the charge/discharge circuit 6, but not limited thereto, may be disposed between the charge/discharge circuit 6 and the storage device 5. In this instance also, the detection means 64 is configured to measure the charge/discharge current amount of the storage device 5 and to deliver the measured value to the charge/discharge control means 8.

It has been described in the foregoing description that a current reversible chopper circuit is generally employed for the charge/discharge circuit 6, and a PWM signal is in many case used for a control signal that is issued by the charge/discharge control means 8 to the charge/discharge circuit 6. The present embodiment will also be described in accordance with this example; however, the charge/discharge circuit 6 or the control signal will not be necessarily described in accordance with the example.

Further, a figure in a bracket symbol [ ] in the present specification denotes a unit of a physical amount. This representation aims to improve clearness of symbols used in the description, and the invention is not limited to a physical quantity in the bracket symbol.

FIG. 6 is a schematic graph showing electric power consumption of an AC motor according to Embodiment 1. Now, consider an instance where, for example, the power consumption Pload [W] is generated by repeating a motoring operation and a regenerative operation, as shown in bold lines of FIG. 6, and electric power that is to be supplied via the converter 1 from the AC electric power supply needs to be reduced to a threshold value of PthB [W] or less, and electric power that is to be regenerated by the converter 1, to be retained at a threshold value of PthA [W] (PthA<0) or greater.

Here, the threshold value PthB [W] is an upper limit value of an electric power supply amount in the motoring mode of the AC motor, the limit value being defined by conditions, such as electric power conversion capability of the converter 1, constraints of power amount that is supplied to the converter 1, and economical requirements associated with the purchase of electric power. The threshold value PthB [W] is, for example, the rated electric power value of the converter 1, or a value slightly smaller than the rated electric power value thereof. Also, the threshold value PthB [W] is, for example, a value of electric power supply capacity at a factory or business facility where an AC motor drive system is installed, or alternatively a value slightly smaller than the value of electric power supply capacity. The threshold value PthB [W] may be determined to take, for example, the contract demand amount between an electric power company and the factory or business facility where the AC motor drive system is installed, or alternatively an electric power amount that is derived from the contract demand amount and can be consumed by the AC motor drive system.

In contrast, the threshold value PthA [W], which is a negative value, is a lower limit value of a regenerative electric power amount of the AC motor in the regenerative mode, the lower limit value being defined by conditions, such as regeneration capability of the converter 1, constraints of electric power amount that can be stored in the storage device 5, and an electric power amount that is to be consumed in a next coming motoring operation. In, for example, the regenerated power dissipating resistor type converter 1, the threshold value PthA [W] is a sign inversed value of absolute value of an electric power amount that can be dissipated in the resistor 122, or alternatively a sign inversed value slightly smaller than an absolute value of the electric power amount that can be dissipated. When the converter 1 is of the type that returns regenerated electric power to the electric power supply, the threshold value PthA [W] is, for example, a sign inversed value of absolute value of the rated regenerative electric power, or a sign inversed value slightly smaller than an absolute value of the rated value. Further, the threshold value PthA [W] is, for example, a sign inversed value of an absolute value of electric power calculated from an electric charge that can be charged to the storage device 5, or alternatively, a sign inversed value slightly smaller than the absolute value of the chargeable electric power. The threshold value PthA [W] may be determined to take, for example, a sign inversed value of an electric power amount that is to be consumed in a next coming motoring operation in the AC motor drive system, or a sign inversed value slightly greater than the power amount to be consumed in the motoring operation, or a sign inversed value slightly smaller than the power amount to be consumed in the motoring operation.

The charge/discharge control means 8 controls the charge/discharge circuit 6 by issuing an control signal, to thereby cause the storage device 5 to store an amount of electric power (an area A portion of FIG. 6), from among amounts of electric power generated by the AC motor during its regenerative operation, that exceeds the threshold value PthA [W]. Further, the charge/discharge control means 8 controls the charge/discharge circuit 6, to thereby cause the storage device 5 to discharge an amount of electric power (an area B portion of FIG. 6), from among amounts of electric power needed for the motoring operation of the AC motor, that exceeds the threshold value PthB [W].

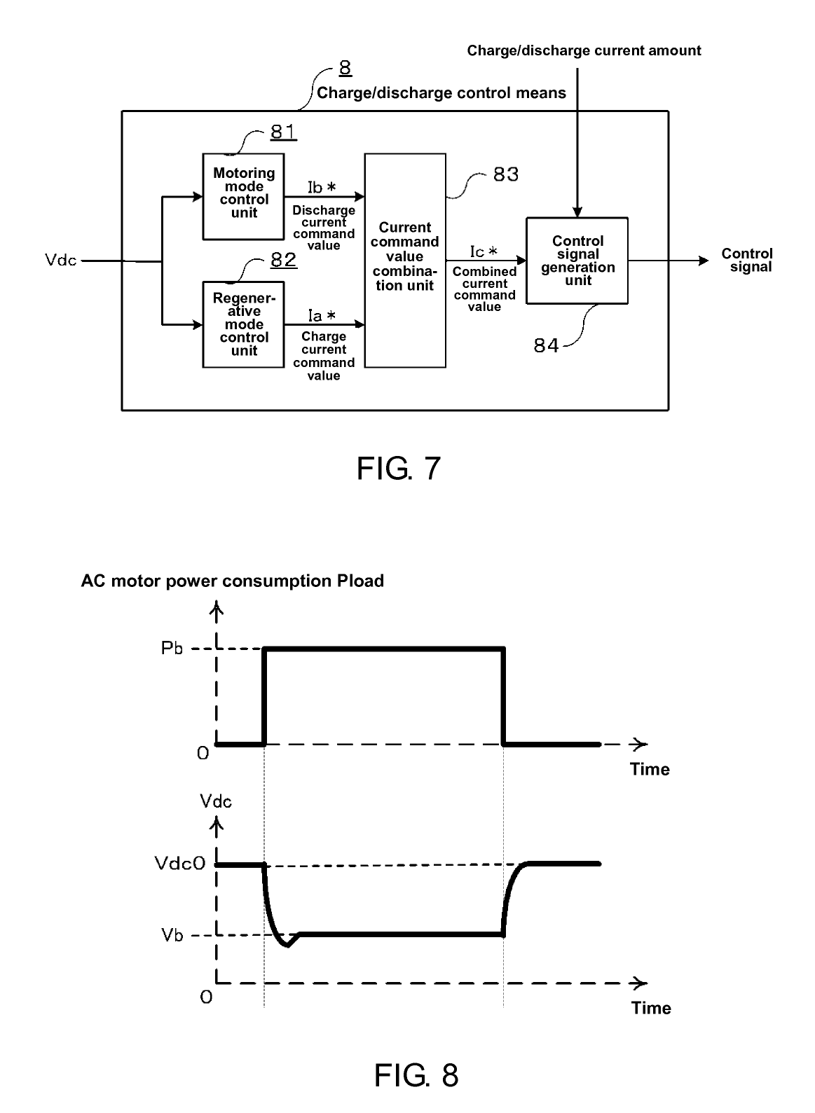

FIG. 7 is a block diagram showing a configuration of the charge/discharge control means 8. A motoring mode control unit 81 generates, based on the voltage value Vdc [V] that is an output from the DC voltage value detection means 7, a discharge current command value Ib* [A]—a command value for a current amount which causes the current amount to be discharged via the charge/discharge circuit 6 from the storage device 5. A regenerative mode control unit 82 generates, similarly based on the voltage value Vdc [V] which is the output from the DC voltage value detection means 7, a charge current command value Ia* [A]—a command value for a current amount which causes the current amount to be charged via the charge/discharge circuit 6 to the storage device 5.

A current command value combination unit 83 combines the discharge current command value Ib* [A] with the charge current command value Ia* [A], to deliver an combined current command value Ic* [A]—a command value for a current amount which causes the current amount to be charged to the storage device 5 or discharged therefrom.

A control signal generation unit 84 generates a control signal that is issued to the charge/discharge circuit 6, from the combined current command value Ic* [A], and the charge/discharge current amount that flows through the charge/discharge circuit 6 and that is measured by the charge/discharge current amount detection means 64.

An instance will next be described in which the AC motor performs the motoring operation. In the AC motor drive system, the AC electric power from the AC electric power supply will not be supplied limitlessly. For this reason, as shown in FIG. 8, when the AC motor performs the motoring operation under an electric power load Pb [W], the DC bus 2 voltage value Vdc [V] lowers to the value Vb [V] owing to an influence of impedance of the converter 1.

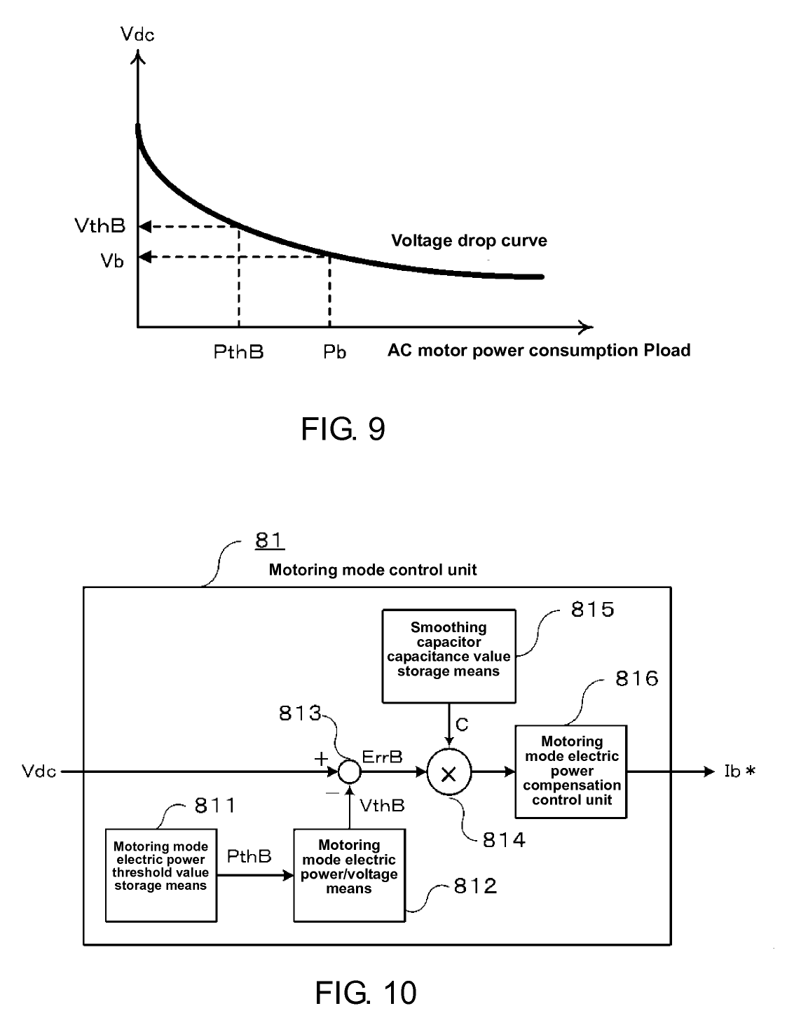

A relationship between an electric power load, during motoring operation of the AC motor, and a DC bus 2 voltage value undergoing a voltage drop, can be calculated by, for example, circuit simulations. The relationship between the load electric power and the DC bus 2 voltage value can also be calculated by specifications for a converter and an AC reactor of the system under consideration. The relationship between the electric power load and the DC bus 2 voltage value can also be calculated by estimation from data actually measured in a prototype/preproduction device. The relationship therebetween can also be calculated from past record values in another already-delivered large-capacity system. Further, the relationship therebetween can be calculated by a combination of the above items, or the like. This can establish the relationship therebetween on a one to one basis, thereby defining a voltage drop curve as shown in a bold line of FIG. 9.

From this voltage drop curve, the DC bus 2 voltage value VthB [V] corresponding to the threshold value PthB [W] can be calculated. Accordingly, by regulating the DC bus 2 voltage value Vdc [V] to the value VthB [V], electric power that is to be supplied via the converter 1 from the AC electric power supply is reduced to the threshold value PthB [W]. And the regulation of the DC bus 2 voltage value Vdc [V] to the value VthB [V] is achieved by supplying the electric power of the area B portion of FIG. 6 from the storage device 5 to the DC bus 2.

On the other hand, if a Laplace operator is represented as s and an amount of current flowing through the smoothing capacitor 3, as Is [A], then the following relationship holds:

Is=s×C×Vdc Equation 1

Hence, controlling the DC bus 2 voltage value Vdc [V] can be achieved by controlling the current amount that flows through the smoothing capacitor 3. Accordingly, when electric power of the area B portion of FIG. 6 is provided from the storage device 5 to the DC bus 2, the DC bus 2 voltage value Vdc [V] is controlled to be the value VthB [V] by regulating an amount of current that is discharged from the storage device 5 to the DC bus 2.

A configuration and operation of the motoring mode control unit 81 for embodying the above idea will be described with reference to FIG. 10. Motoring mode electric power threshold value storage means 811 has the threshold value PthB [W] pre-recorded therein. The motoring mode electric power threshold value storage means 811 delivers the threshold value PthB [W] to motoring mode electric power/voltage means 812.

The motoring mode electric power/voltage means 812 contains beforehand voltage drop characteristic curve data, as shown in FIG. 9, by means such as an approximate expression or look-up table (LUT). The motoring power/voltage means 812 calculates, using this voltage drop characteristic curve data, the voltage value VthB [V] corresponding to the threshold value PthB [W], to deliver the calculated voltage value to a subtraction means 813.

The subtraction means 813 receives the DC bus 2 voltage value Vdc [V] measured by the DC voltage value detection means 7, and the voltage value VthB [V] which is the output from the motoring power/voltage means 812. The subtraction means 813 calculates the difference between the voltage values Vdc [V] and VthB [V], to deliver a calculation result ErrB [V] to multiplication means 814.

Smoothing capacitor capacitance value storage means 815 has a capacitance value C [F] of the smoothing capacitor 3 pre-recorded therein. The smoothing capacitor capacitance value storage means 815 delivers the capacitance value C [F] of the smoothing capacitor 3 to the multiplication means 814.

The multiplication means 814 multiplies the calculation result ErrB [V], which is the output from the subtraction means 813, by the smoothing capacitor 3 capacitance value C [F], to deliver the multiplication result to a motoring mode electric power compensation control unit 816. Here, in the descriptions to follow, the subtraction means 813 and the multiplication means 814 are collectively treated as motoring mode calculation means.

The motoring mode electric power compensation control unit 816 generates from the output of the multiplication means 814 the discharge current command value Ib* [A]—the command value for an amount of discharge current of the storage device 5 which flows via the charge/discharge circuit 6. This calculation is performed by proportional integral control (PI control), integral control (I control), or proportional integral differential control (PID control). The power compensation control unit 816 delivers the generated discharge current command value Ib* [A] to the current command value combination unit 83.

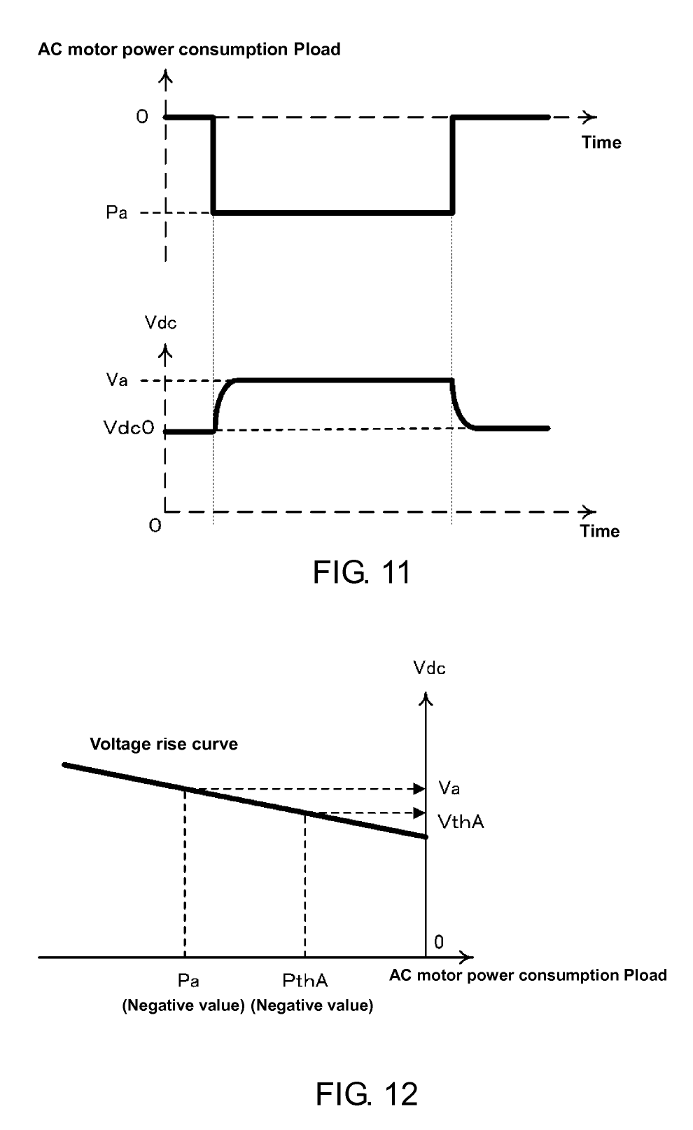

An instance will next be described in which the AC motor performs the electric power regeneration. When the RPM of the AC motor decreases, or some external force is applied thereto, the AC motor regenerates electric power of Pa [W] (negative value), as shown in FIG. 11. The regenerative electric power Pa [W] regenerated via the inverter 4 by the AC motor is stored in the smoothing capacitor 3, and the DC bus 2 voltage value Vdc [V] is increased to a value Va [V]. When the converter 1 is of regenerated power dissipating resistor type, the DC bus 2 voltage value Vdc [V] retains the value Va [V] when the value Va [V] is in a range until the regenerated power dissipating resistor circuit 12 starts its operation, i.e., until the switching element 121 becomes conductive. And the converter 1, when being of the type that returns regenerated power to an electric power supply, returns to the AC power supply, electric power according to the amount of this voltage rise, owing to an influence of impedance of the converter 1.

The relationship between the regenerative electric power, during regenerative operation of the AC motor, and a voltage value of the DC bus 2 having a voltage rise, can be calculated by, for example, circuit simulations. Further, the relationship between the regenerative electric power and the DC bus 2 voltage value can also be calculated by specifications for a convertor and an AC reactor of the system under consideration. The relationship therebetween can also be calculated by estimation from data actually measured in a prototype/preproduction device. The relationship therebetween can also be calculated by past result values in another already-delivered large-capacity system. In addition, the relationship therebetween can also be calculated by a combination of the above items, or the like. This can establish the relationship therebetween on a one to one basis, thereby defining a voltage rise curve as shown in a bold line of FIG. 12.

The DC bus 2 voltage value VthA [V] corresponding to the threshold value PthA [W] can be calculated from this voltage rise curve. Accordingly, by regulating the DC bus 2 voltage value Vdc [V] to the value VthA [V], electric power that is regenerated by the converter 1 will be reduced to the threshold value PthA [W]. And the regulation of the DC bus 2 voltage value Vdc [V] to the value VthA [V] is achieved by supplying electric power of the area A portion of FIG. 6 to the DC bus 2, more specifically, from the smoothing capacitor 3 via the charge/discharge circuit 6 to the storage device 5, and charging the storage device.

In addition, as with the motoring operation mode, the relationship of Equation 1 holds also for the regenerative operation mode. From this fact, the control of the DC bus 2 voltage value Vdc [V] can be achieved by regulating an amount of current flowing through the smoothing capacitor 3. Accordingly, when the electric power of the area A portion of FIG. 6 is charged from the DC bus 2 to the storage device 5, the DC bus 2 voltage value Vdc [V] is controlled to be the value VthA [V] by regulating an amount of current that is charged from the DC bus 2 to the storage device 5.

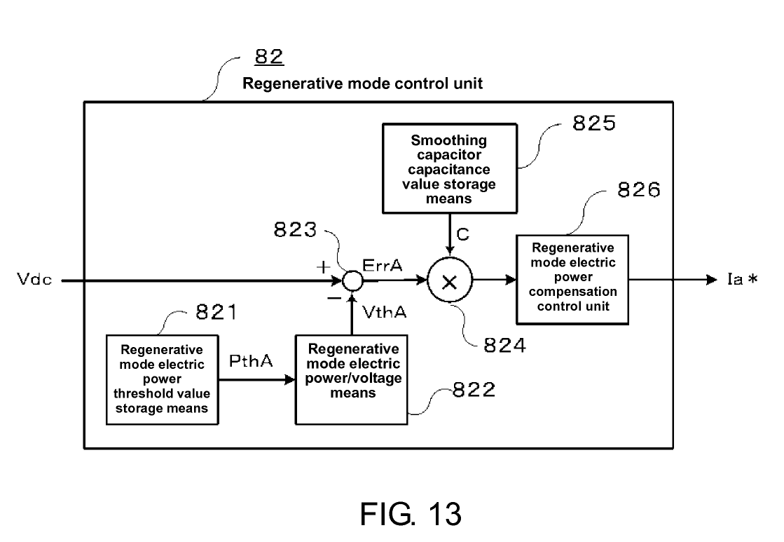

A configuration and operation of the regenerative mode control unit 82 for embodying the above idea will be described with reference to FIG. 13. Regenerative mode electric power threshold value storage means 821 has the threshold PthA [W] pre-recorded therein. The regenerative mode electric power threshold value storage means 821 delivers the threshold PthA [W] to regenerative mode electric power/voltage means 822.

The regenerative mode electric power/voltage means 822 contains beforehand voltage rise characteristic curve data, shown in FIG. 12, by means such as an approximation expression or LUT. The regenerative power/voltage means 822 calculates, using this voltage rise characteristic curve data, the voltage value VthA [V] corresponding to the threshold value PthA [W], and delivers the calculated value to subtraction means 823.

The subtraction means 823 receives the DC bus 2 voltage value Vdc [V], measured by the DC voltage value detection means 7, and the voltage value VthA [V], which is the output from the regenerative power/voltage means 822. The subtraction means 823 calculates the difference between the voltage values Vdc [V] and VthA [V], to deliver the calculation result ErrA [V] to multiplication means 824.

Smoothing capacitor capacitance value storage means 825 has the capacitance value C [F] of the smoothing capacitor 3 pre-recorded therein, and delivers the capacitance value C [F] thereof to the multiplication means 824.

The multiplication means 824 multiplies the value ErrA [V], which is the output from the subtraction means 823, by the capacitance value C [F] thereof, and delivers the calculation result to a regenerative mode electric power compensation control unit 826. Note that in the descriptions to follow, the subtraction means 823 and the multiplication means 824 are collectively treated as regenerative mode calculation means.

The regenerative mode electric power compensation control unit 826 generates from the output of the multiplication means 824 the charge current command value Ia* [A], which is a command value for an amount of charge current flowing via the charge/discharge circuit 6 into the storage device 5. This calculation is performed by the PI control, I control or PID control. The power compensation control unit 826 delivers the generated charge current command value Ia* [A] to the current command value combination unit 83.

Operations of the current command value combination unit 83 and the control signal generation unit 84 during motoring operation and regenerative operation will be described next. The current command value combination unit 83 adds together the discharge current command value Ib* [A], which is the output from the motoring mode control unit 81, and the charge current command value Ia* [A], which is the output from the regenerative mode control unit 82, to generate the combined current command value Ic* [A] and then deliver it to the control signal generation unit 84.

In the current command value combination unit 83, however, the discharge current command value Ib* [A] and the charge current command value Ia* [A] are opposite in sign.

In other words, in the AC motor drive system, if the charge current into the storage device 5 is defined to be positive, then the discharge current command value Ib* [A] is converted to zero or a negative value and treated as such, and the charge current command value Ia* [A] is converted to zero or a positive value and treated as such.

Conversely, in the AC motor drive system, if the discharge current from the storage device 5 is defined to be positive, then the discharge current command value Ib* [A] is converted to zero or a positive value and treated as such, and the charge current command value Ia* [A] is converted to zero or a negative value and treated as such.

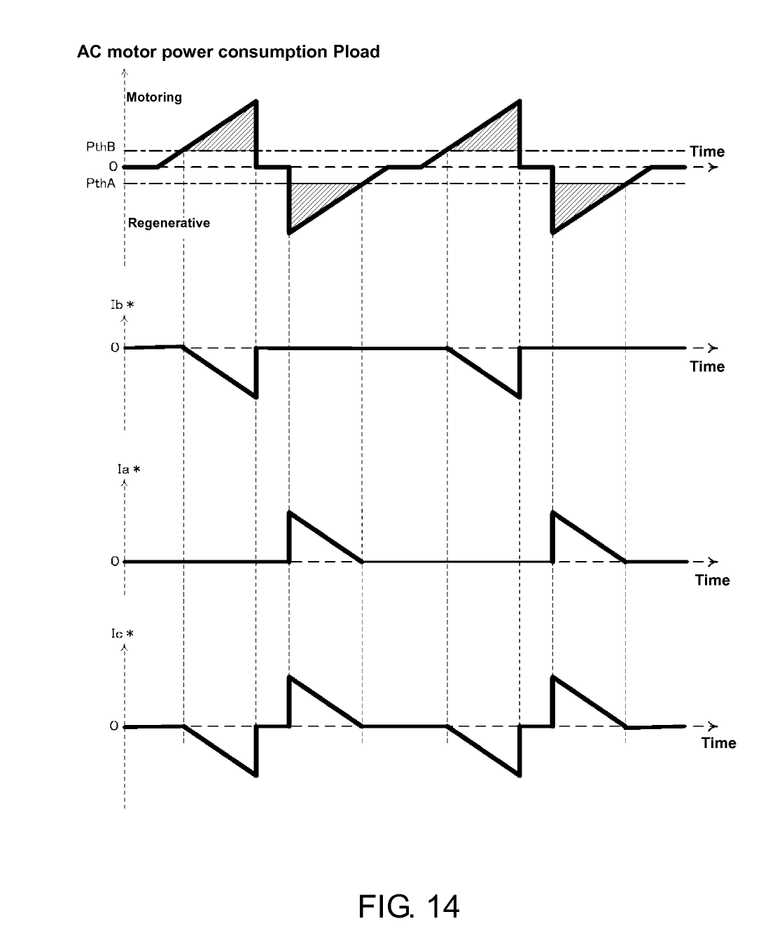

FIG. 14 schematically illustrates, in the AC motor drive system according to Embodiment 1, relationships between the AC motor electric power consumption Pload [W] where the charge current into the storage device 5 is defined to be positive and each of the Pload's corresponding values: the discharge current command value Ib* [A], the charge current command value Ia* [A] and the combined current command value Ic* [A].

The control signal generation unit 84 generates a voltage command value (not shown) for causing charge/discharge current corresponding to the combined current command value Ic* [A] to flow into the charge/discharge circuit 6. More specifically, based on an amount of the charge/discharge current flowing into the charge/discharge circuit 6 measured by the charge/discharge current amount detection means 64—and on the combined current command value Ic* [A], the calculation is performed by providing the PI, I, or PID control.

The voltage command value generated is compared to a carrier waveform where a triangular waveform is generally used. Based on the comparison result, the control signal generation unit 84 converts the voltage command value to a control signal, which is a PWM signal. The control signal generation unit 84 delivers this control signal to the driver circuits 63 of the charge/discharge circuit 6. In the charge/discharge circuit 6, each of the switching elements 62 is switched from an on-state to an off-state and vice versa in response to the control signal, and the charge/discharge current flows corresponding to the combined current command value Ic* [A].

By configuring the AC motor drive system in this way, electric power during motoring operation which is to be supplied via the converter 1 from the AC electric power supply can be reduced to the predetermined threshold value PthB [W] without using an amount of current flowing through the DC bus 2. Also, without using the amount of current flowing through the DC bus 2, regenerative mode electric power that is to be regenerated by the converter 1 can be retained at the predetermined threshold value PthA [W].

In Embodiment 1, means that measures the amount of current flowing through the DC bus 2 (hereinafter called DC bus current amount detection means) does not need to be provided; thus, AC motor drive systems can be manufactured at low price.

In addition, since the DC bus current amount detection means does not need to be provided, small-sized AC motor drive systems can be manufactured, and resource saving and cost reduction can also be made. Also, flexibility is increased for the location of installation of the AC motor drive system.

In some occasions, the DC bus current amount detection means generates heat; thus, when the DC bus current amount detection means is used, some measures need to be taken for heat radiation, resulting in a factor that causes cost increases for AC motor drive systems. However, the AC motor drive system according to Embodiment 1 does not need to include the DC bus current amount detection means; thus, no heat radiation measures are needed for the DC bus current amount detection means, which also achieves cost or size reduction of the AC motor driving system.

In addition, the DC bus current amount detection means includes one that is magnetically saturated. When it is magnetically saturated, a precise amount of current cannot be grasped. This prevents the achievement of electric power peak cut capability as shown in the present embodiment and thus, there is a possibility of malfunction or failure of the entire system. According to the present embodiment, however, since DC bus current amount detection means does not need to be disposed, no magnetic saturation occur that can take place in the DC bus current amount detection means made up of a magnetic material. This can also avoid a problem associated with error detection, due to the magnetic saturation, of electric power during motoring operation or regenerative operation.

Note that configurations of the motoring mode control unit 81 and the regenerative mode control unit 82 are not limited to the foregoing configurations. For example, the subtraction means 813 and the multiplication means 814 in the motoring mode calculation means may be exchanged with each other. In other words, two multiplication means may be provided independently: one that receives the voltage value Vdc [V] and the capacitance value C [F] of the smoothing capacitor 3, and the other that receives the voltage value VthB [V] and the capacitance value C [F] thereof. And each of the multiplication means may separately multiply the voltage value Vdc [V] by the capacitance value C [F], and the voltage value VthB [V] by the capacitance value C [F], to deliver its multiplication result to the subtraction means 813. The subtraction means 813 may calculate a difference between the received multiplication results from the respective multiplication means, to deliver the calculation result ErrB [V] to the motoring mode electric power compensation control unit 816.

The same applies for the regenerative mode calculation means. The two multiplication means—one that receives the voltage value Vdc [V] and the other that receives the voltage value VthA [V]—are provided independently, and the capacitance value C [F] of the smoothing capacitor 3 may be multiplied using the respective multiplication means. And the respective multiplication results are delivered to the subtraction means 823, which in turn calculates the difference between them. The subtraction means 823 may deliver the calculation result ErrA [V] to the regenerative mode electric power compensation control unit 826.

In addition, the motoring mode control unit 81 and the regenerative mode control unit 82 may be configured not to include smoothing capacitor capacitance value storage means 815, 825, respectively. And they may also be configured not to include multiplication means 814, 824.

In this instance, independent of the capacitance value C [F], the power compensation control unit 816 generates the discharge current command value Ib* [A], based on ErrA [V] which is the output from the subtraction means 813. In addition, when the power compensation control unit 816 performs calculations, multiplication of the capacitance value C [F] may be made.

The same applies for the regenerative mode electric power compensation control unit 826. Independent of the capacitance value C [F], the power compensation control unit 826 may generate the charge current command value Ia* [A], based on ErrA [V], which is the output from the subtraction means 823, or alternatively, when the power compensation control unit 826 performs calculations, multiplication of the capacitance value C [F] may be made.

Further, the motoring mode calculation means has, but is not limited to, the subtraction means 813. For example, comparison means may be provided in place of having the subtraction means 813. In this instance, the comparison means receives the voltage values Vdc [V] and VthB [V], and compares these values alone. The comparison means delivers the comparison result toward the power compensation control unit 816. The power compensation control unit 816 generates, based on the comparison result, the discharge current command value Ib* [A] for lowering the voltage value Vdc [V] to the voltage value VthB [V] or smaller, to deliver the generated value to the current command value combination unit 83.

The same applies also for the subtraction means 823 included in the regenerative mode calculation means, and instead the comparison means may be provided. In this instance, the comparison means compares the received voltage value Vdc [V] with the voltage value VthA [V], to deliver the comparison result toward the regenerative mode electric power compensation control unit 826. The power compensation control unit 826 generates, based on the comparison result, the charge current command value Ia* [A] for increasing the voltage value Vdc [V] to the voltage value VthA [V] or greater, to deliver the generated value to the current command value combination unit 83.

### Embodiment 2

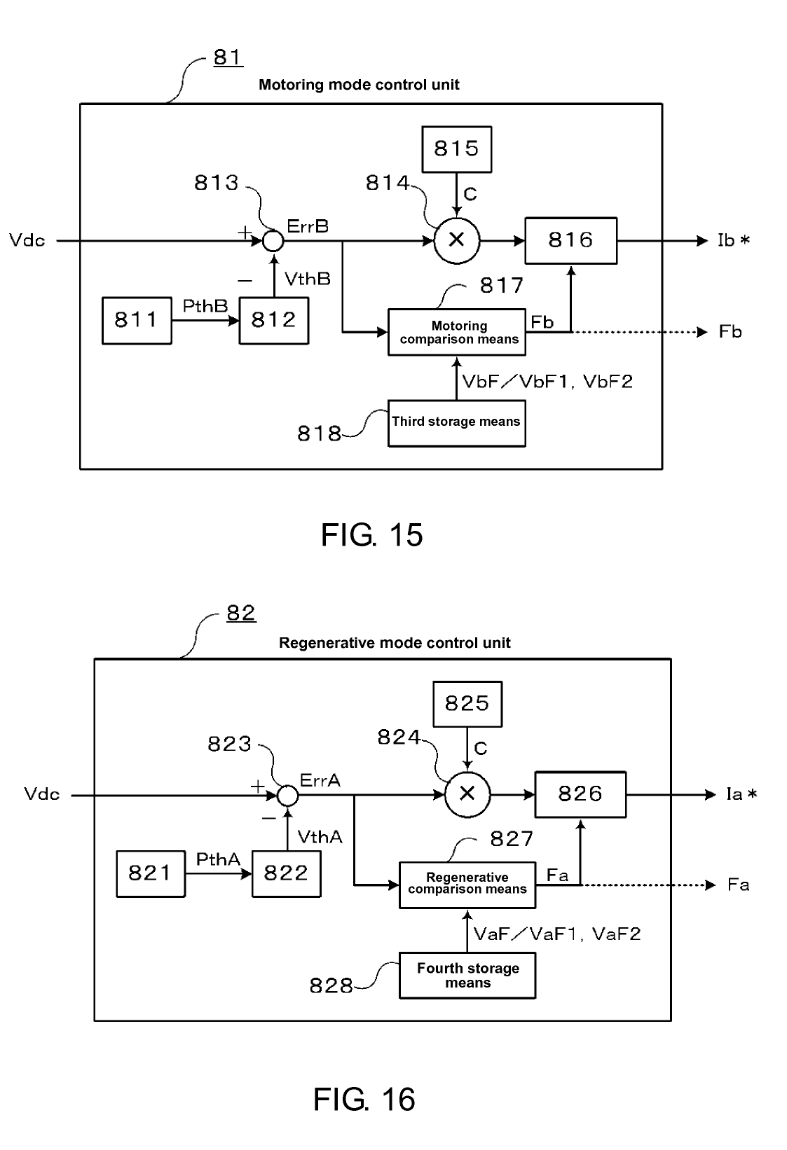

The motoring mode control unit 81 in another embodiment different from Embodiment 1 will be described with reference to FIG. 15. Note that in the present embodiment, the same or similar means as those in Embodiment 1 are shown by the same designations and symbols, and their descriptions will not be provided herein.

In addition to the configuration of the motoring mode control unit 81 according to Embodiment 1, the motoring mode control unit 81 according to Embodiment 2 further includes motoring comparison means 817, and third storage means 818 that is provided separately from the motoring mode electric power threshold value storage means 811 and the smoothing capacitor capacitance value storage means 815.

Operating principles of an AC motor drive system according to Embodiment 2 during motoring operation will be described. In some situations, noise may be combined to the DC bus 2 voltage value Vdc [V] measured by the DC voltage value detection means 7. In particular, in a low power consumption mode, even when an operation that causes electric power to be discharged from the electric power storage device 5 (hereinafter called electric power assist operation) is not fundamentally needed, the electric power assist operation may in some cases be performed. And, the motoring mode electric power compensation control unit 816, or the control signal generation unit 84 contains an integral element. For this reason, once the system has been put into electric power assist operation, the system cannot immediately correct this operation for a while after the noise has disappeared, nor can it demonstrate the desired capability.

Conversely, although the electric power assist operation is needed, the noise combined to the above voltage value may in some situations cause the electric power assist operation to stop, and thereby a time delay from the disappearance of noise to re-start of the electric power assist operation may in some cases occur. In other words, some preventive measure is needed for eliminating the time delay after the noise disappearance and immediately performing the electric power assist operation or the like.

Accordingly, a motoring mode mask signal Fb is used to thereby lessen an influence of the noise, the motoring mode mask signal controlling the motoring mode electric power compensation control unit 816 so that it is in a state A—a state where the operation of the power compensation control unit stops—or alternatively so that it is in a state B—a state where the discharge current command value Ib* [A], which is the output from the power compensation control unit 816, is forcefully converted to zero.

Operation of the motoring mode control unit 81 according to Embodiment 2 will next be described with reference to FIG. 15. The third storage means 818 has zero or a small amount of negative value pre-recorded therein as a threshold value VbF (≦0). The motoring comparison means 817 receives the output ErrB [V] from the subtraction means 813, and the threshold value VbF stored in the third storage means 818.

When the output ErrB [V] from the subtraction means 813 is the threshold value VbF or greater, the motoring comparison means 817 generates the motoring mask signal Fb. Then, the comparison means 817 issues the motoring mask signal Fb to the power compensation control unit 816. In response to the motoring mask signal Fb, the motoring comparison means 817 controls the power compensation control unit 816 so that it is in the state A or state B.

Thereafter, when the output ErrB [V] from the subtraction means 813 is smaller than the threshold value VbF, the comparison means 817 changes the motoring mask signal Fb into a signal by which the state A and state B are both canceled.

By configuring the motoring mode control unit 81 as described above, interruption of the discharge current command value Ib* [A] can be prevented in the motoring operation of the AC motor drive system in the low power consumption mode. This allows for smooth electric power compensation operation.

Here, a configuration of the motoring mode control unit 81 according to Embodiment 2 is not limited to this configuration. For example, the motoring mode control unit may be configured such that two values VbF1 and VbF2 (VbF1<VbF2≦0), each of which is zero or a small amount of negative value, are pre-recorded, as threshold values, in the third storage means 818. In this instance, the motoring comparison means 817 controls, until the value ErrB [V] is smaller than the value VbF1, the power compensation control unit 816 so that it is in the state A or state B. And once ErrB [V] becomes smaller than VbF1, the motoring comparison means 817 activates the power compensation control unit 816, to cause it to deliver the discharge current command value Ib* [A], other than zero. Thereafter, the motoring comparison means 817, when ErrB [V] next becomes VbF2 or greater, again controls the power compensation control unit 816 so that it is in the state A or state B. The foregoing advantageous effects are achieved also when the hysteretic motoring mask signal Fb is employed which achieves such control operations.

In addition to issuing the motoring mask signal Fb to the power compensation control unit 816, the motoring comparison means 817 may issue the motoring mask signal Fb to an external portion of the motoring mode control unit 81 (a portion shown in dotted lines of FIG. 15). In this instance, the motoring comparison means 817 issues the motoring mask signal Fb to the control signal generation unit 84. With such a configuration, the motoring comparison means 817 can control, in response to the state A of the power compensation control unit 816, the control signal generation unit 84 so that it is placed in a non-operational state. In addition, in response to the state B of the power compensation control unit 816, the motoring comparison means 817 may control the state of the control signal generation unit 84, and thereby control a control signal, which is an output from the control signal generation unit. In this instance, the state of the control signal generation unit 84 can be controlled so that, from among the control signals, a control signal associated with discharging of the storage device 5 is a control signal that forcefully places the switching element 62 in an off state.

When the control signal generation unit 84 is controlled in this way using the motoring mask signal Fb, the possibility that the switching elements 62 in the charge/discharge circuit 6, which is a chopper circuit, is short-circuited between the DC bus 2 lines, can be reduced during motoring operation in the low power consumption mode, or during switchover between the motoring operation and the regenerative operation, in the AC motor drive system. This can avoid failure of the charge/discharge circuit 6, or even extend the life-spans of the switching elements 62. Further, this leads to expectations even for avoidance of the failed AC motor drive system or for extension of the device life-span.

The regenerative mode control unit 82 in another embodiment different from Embodiment 1 will next be described with reference to FIG. 16. In addition to the configuration of the regenerative mode control unit 82 according to Embodiment 1, the control unit 82 according to Embodiment 2 further includes regenerative comparison means 827, and fourth storage means 828 that is provided separately from the regenerative mode electric power threshold value storage means 821 and the smoothing capacitor capacitance value storage means 825.

Operating principles of an AC motor drive system according to Embodiment 2 during regenerative operation will be described. As with the motoring operation mode, in the regenerative operation mode also, noise may in some situations be combined to the DC bus 2 voltage value Vdc [V] measured by the DC voltage value detection means 7, thereby causing the system to malfunction. Because of this, a time delay from the disappearance of noise to re-start of the electric power assist operation needs to be eliminated.

Accordingly, a regenerative mode mask signal Fa is used to thereby lessen an influence of the noise, the regenerative mode mask signal controlling the power compensation control unit 826 so that it is in a state C—a state where the operation of the power compensation control unit stops—or alternatively so that it is in a state D—a state where the charge current command value Ia* [A], which is the output from the power compensation control unit 826, is forcefully converted to zero.

Operation of the regenerative mode control unit 82 according to Embodiment 2 will next be described with reference to FIG. 16. The fourth storage means 828 has zero or a small amount of positive value pre-recorded therein as a threshold value VaF (≧0). The regenerative comparison means 827 receives the output ErrA [V] from the subtraction means 823, and the threshold value VaF stored in the fourth storage means 828.

When the output ErrA [V] from the subtraction means 823 is the threshold value VaF or smaller, the regenerative comparison means 827 generates the regenerative mask signal Fa. Then, the comparison means 827 issues the regenerative mask signal Fa to the power compensation control unit 826. In response to the regenerative mask signal Fa, the comparison means 827 controls the power compensation control unit 826 so that it is in the state C or state D.

Thereafter, when the output ErrA [V] from the subtraction means 823 is greater than the threshold value VaF, the comparison means 827 changes the regenerative mask signal Fa into a signal by which the state C and state D are both canceled.

By configuring the regenerative mode control unit 82 as described above, interruption of the charge current command value Ia* [A] can be prevented in the regenerative operation of the AC motor drive system in the low power consumption mode. This allows for the smooth electric power compensation.

Here, a configuration of the regenerative mode control unit 82 according to Embodiment 2 is not limited to this configuration. For example, the regenerative mode control unit may be configured such that two values VaF1 and VaF2 (VaF1>VaF2≧0), each of which is zero or a small amount of positive value, are pre-recorded, as threshold values, in the fourth storage means 828. In this instance, the regenerative comparison means 827 controls, until the value ErrA [V] is greater than the value VaF1, the power compensation control unit 826 so that it is in the state C or state D. And once ErrA [V] becomes greater than VaF1, the comparison means 827 activates the power compensation control unit 826, to cause it to deliver the charge current command value Ia* [A], other than zero. Thereafter, the comparison means 827, when ErrB [V] next becomes VaF2 or smaller, again controls the power compensation control unit 826 so that it is in the state C or state D. The foregoing advantageous effects are achieved also when the hysteretic regenerative mask signal Fa is employed which achieves such control operations.

In addition to issuing the regenerative mask signal Fa to the power compensation control unit 826, the regenerative comparison means 827 may issue the regenerative mask signal Fa to an external portion of the regenerative mode control unit 82 (a portion shown in dotted lines of FIG. 16). In this instance, the comparison means 827 issues the regenerative mask signal Fa to the control signal generation unit 84. With such a configuration, the comparison means 827 can control, in response to the state C of the power compensation control unit 826, the control signal generation unit 84 so that it is placed in a non-operational state. In addition, in response to the state D of the power compensation control unit 826, the comparison means 827 may control the state of the control signal generation unit 84, and thereby control a control signal, which is an output from the control signal generation unit. In this instance, the state of the control signal generation unit 84 can be controlled so that, from among the control signals, a control signal associated with charging of the storage device 5 is a control signal that forcefully places the switching element 62 in an off state.

When the control signal generation unit 84 is controlled in this way using the regenerative mask signal Fa, the possibility that the switching elements 62 in the charge/discharge circuit 6, which is the chopper circuit, is short-circuited between the DC bus 2 lines can be reduced during regenerative operation in the low power consumption mode, or during switchover between the regenerative operation and the motoring operation, in the AC motor drive system. This can avoid failure of the charge/discharge circuit 6, or even extend the life-spans of the switching elements 62. Further, this leads to expectations even for avoidance of the failed AC motor drive system or for extension of the device life-span.

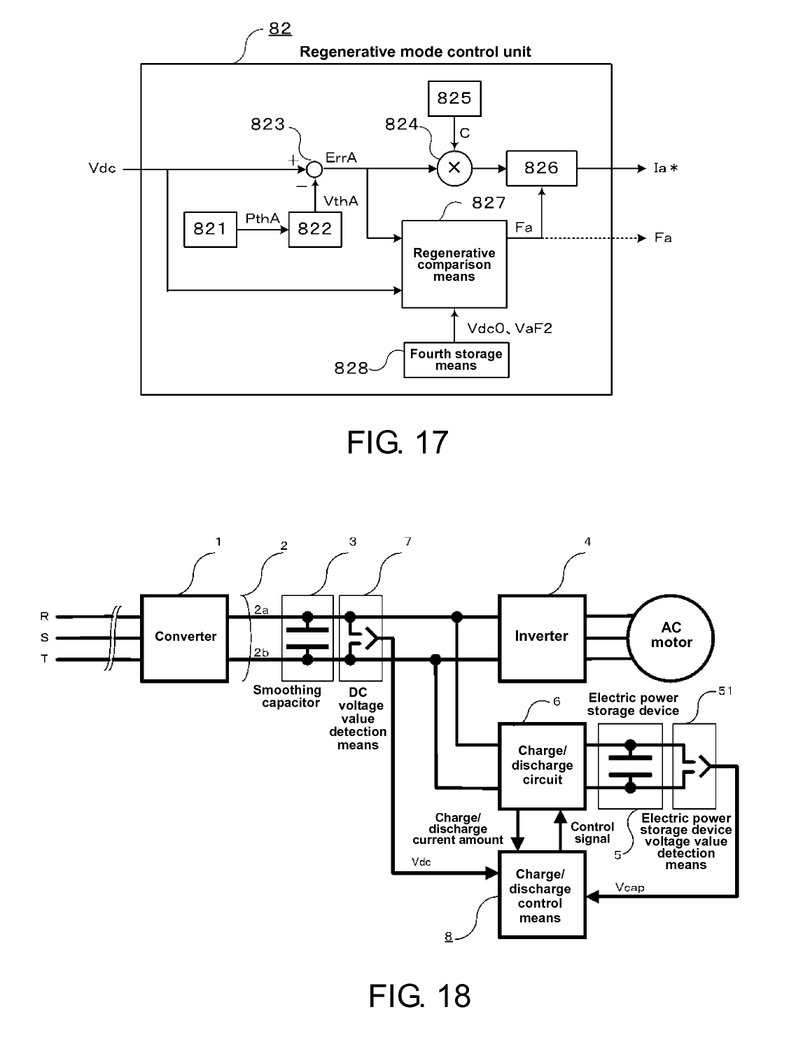

Further, the fourth storage means 828 may be configured such that the DC bus 2 voltage value Vdc0 [V] (refer to FIGS. 8 and 11) resulting from the AC motor not operating in a motoring operation mode or regenerative operation mode is pre-recorded together with the above threshold value VaF2. In this instance, the regenerative comparison means 827 receives the DC bus 2 voltage value Vdc [V], the threshold value VaF2 [V] and the voltage value Vdc0 [V], together with ErrA [V], as shown in FIG. 17.

The comparison means 827, when the voltage value Vdc [V] is greater than Vdc0 [V], immediately changes the regenerative mask signal Fa into a signal that activates the regenerative mode compensation control unit 826. And the comparison means 827 retains the regenerative mask signal Fa so that the power compensation control unit 826 continues its operation, so long as ErrA [V] does not become VaF2 or smaller. Thereafter, when ErrA [V] becomes VaF2 or smaller, the comparison means 827 generates the mask signal Fa that controls the power compensation control unit 826 so that it is in the state C or state D. The comparison means 827 issues the generated mask signal Fa to the power compensation control unit 826.

By configuring the regenerative mode control unit 82 in this way, the storage device 5 can start to be charged as soon as the AC motor drive system starts its regenerative operation. As a result, a delay in the control of the system can be reduced to a small extent, thus enabling electric power to be stored in the storage device 5 without needlessly returning the power to the AC electric power supply.

### Embodiment 3

FIG. 18 shows an overall configuration of an AC motor drive system according to Embodiment 3. Here, in the present embodiment, the same or similar means as those in Embodiment 1 and Embodiment 2 are shown by the same designations and symbols, and their descriptions will not be provided herein.

As shown in FIG. 18, electric power storage device voltage value detection means 51, which is connected to the electric power storage device 5, measures a voltage value Vcap [V] across the storage device 5. The electric power storage device voltage value detection means 51 delivers the voltage value Vcap [V] measured thereacross to the charge/discharge control means 8.

In Embodiment 1 or Embodiment 2, the technique is disclosed in which electric power is discharged from the storage device 5 to the DC bus 2 so that the DC bus 2 voltage value Vdc [V] becomes VthB [V], whereby electric power that is to be supplied from the converter 1 to the DC bus 2 can be reduced to the threshold value PthB [W]. In Embodiment 1 or Embodiment 2, the discharge current command value Ib* [A] that is delivered by the motoring mode control unit 81 is aimed at controlling the amount of current flowing between the DC bus 2 and the charge/discharge circuit 6. In the descriptions to follow, the amount of current flowing between the DC bus 2 and the charge/discharge circuit 6 is assumed to be a primary current amount i1 [A]. On the other hand, in Embodiment 1 or Embodiment 2, the control signal generation unit 84, which receives the current amount flowing between the storage device 5 and the charge/discharge circuit 6, issues to the driver circuits 63 of the charge/discharge circuit 6 a control signal that controls the amount of current flowing between the DC bus 2 and the charge/discharge circuit 6. In the descriptions to follow, the amount of current flowing between the storage device 5 and the charge/discharge circuit 6 is assumed to be a secondary current amount i2 [A].

Assuming that the chopper circuit of the charge/discharge circuit 6 generates a small loss, then the following relationship holds between the primary current amount it [A] and the secondary current amount i2 [A]:

i1×Vdc=i2×Vcap Equation 2

When the electric power that is to be supplied from the converter 1 to the DC bus 2 is controlled to be reduced to the threshold value PthB [W], an approximation can be made: Vdc=VthB and i1=Ib*. Thus, the following relationship holds by substituting them into Equation 2:

i2=(VthB/Vcap)Ib* Equation 3

When the across-voltage value Vcap varies to a small extent, the value (VthB/Vcap) can be regarded as a constant, and thus the reduction control can be handled by means of the PI, I and PID controls and the like within the control signal generation unit 84. However, when a large amount of power is discharged from the storage device 5 and the across-voltage value Vcap varies greatly, the control cannot be handled with the control signal generation unit 84 alone.

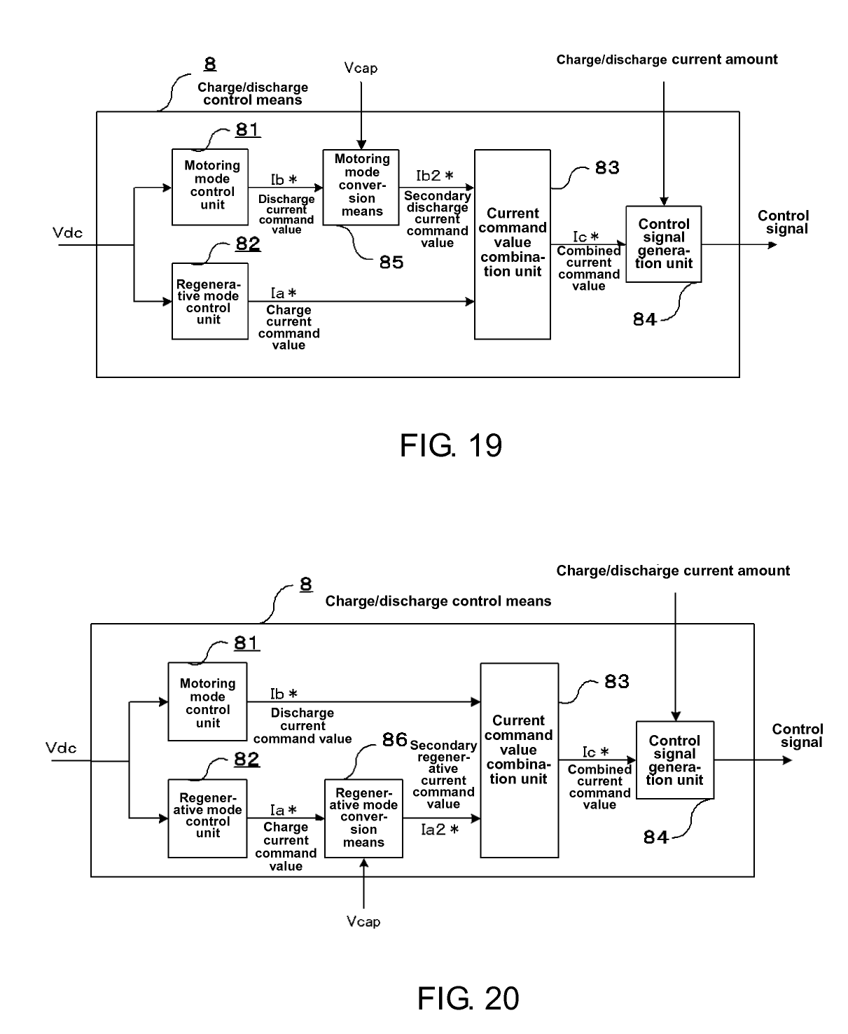

Accordingly, in order to implement Equation 3, motoring mode conversion means 85 is further disposed between the motoring mode control unit 81 and the current command value combination unit 83, as shown in FIG. 19. The motoring mode conversion means 85 receives the discharge current command Ib* [A], which is the output from the motoring mode control unit 81, and the voltage value VthB [V], which is the output from the motoring mode electric power/voltage means 812 within the motoring mode control unit 81, and the across-voltage value Vcap [V], which is the measured value by the electric power storage device voltage value detection means 51. The motoring mode conversion means 85 calculates (VthB/Vcap) Ib* and delivers the calculation result, as the secondary discharge current command value Ib2* [A], to the current command value combination unit 83.

Likewise, in Embodiment 1 or Embodiment 2, a technique is disclosed in which electric power is charged from the DC bus 2 to the storage device 5 so that the DC bus 2 voltage Vdc [V] becomes VthA [V], whereby electric power that is to be regenerated from the DC bus 2 to the converter 1 can be retained at the threshold value PthA [W]. In Embodiment 1 or Embodiment 2, the charge current command value Ia* [A] that is delivered by the regenerative mode control unit 82 is aimed at controlling the primary current amount i1 [A]. On the other hand, in Embodiment 1 or Embodiment 2, the control signal generation unit 84 issues to the driver signal 63 of the charge/discharge circuit 6 a control signal that controls the secondary current amount i2 [A].

Assuming that the chopper circuit of the charge/discharge circuit 6 generates a small loss, then Equation 2 holds between the primary current amount i1 [A] an the secondary current amount i2 [A]. When the electric power that is to be regenerated from the DC bus 2 to the converter 1 is controlled to be reduced to the threshold value PthA [W], an approximation can be made: Vdc=VthA and i1=Ia*. Thus, the following relationship holds by substituting them into Equation 2:

i2=(VthA/Vcap)ia* Equation 4

When the across-voltage value Vcap varies to a small extent, the value (VthA/Vcap) can be regarded as a constant, and thus the reduction control can be handled by means of the PI, I and PID controls and the like within the control signal generation unit 84. However, when a large amount of power is charged to the storage device 5 and the across-voltage value Vcap varies greatly, the control cannot be handled with the control signal generation unit 84 alone.

Accordingly, in order to implement Equation 4, regenerative mode conversion means 86 is further disposed between the regenerative mode control unit 82 and the current command value combination unit 83, as shown in FIG. 20. The regenerative mode conversion means 86 receives the charge current command value Ia* [A], which is the output from the regenerative mode control unit 82, and the voltage value VthA [V], which is the output from the regenerative mode electric power/voltage means 822 within the regenerative mode control unit 82, and the across-voltage value Vcap [V], which is the measured value by the electric power storage device voltage value detection means 51. The regenerative mode conversion means 86 calculate (VthA/Vcap) Ia* and delivers the calculation result, as a secondary discharge current command value Ia2* [A], to the current command value combination unit 83.

Thus far, an embodiment is disclosed in which the motoring mode conversion means 85 and the regenerative mode conversion means 86 are each separately disposed in the charge/discharge control means 8. However, it does not matter if there is the motoring mode conversion means 85 between the motoring mode control unit 81 and the current command value combination unit 83 and if there is the regenerative mode conversion means 86 between the regenerative mode control unit 82 and the current command value combination unit 83, both units being disposed in the charge/discharge control means 8.

In this way, by disposing both or either of the motoring mode conversion means 85 and the regenerative mode conversion means 86 in the charge/discharge control means 8, motoring mode electric power that is to be supplied via the converter 1 from the AC electric power supply can be reduced to the predetermined threshold PthB [W] without using an amount of current flowing through the DC bus 2, even when the across-voltage value of the storage device 5 Vcap [V] varies greatly. Again likewise, even when the across-voltage value Vcap [V] of the storage device 5 varies greatly, regenerative mode electric power that is to be regenerated by the converter 1 can be retained at the predetermined threshold PthA [W] without using the amount of current flowing through the DC bus 2.

Further, the storage device 5 can be operated with its across-voltage value Vcap [V] greatly varied, so that electric potential energy can be increased which can be charged from the DC bus 2 to the storage device 5, or discharged from the storage device 5 to the DC bus 2. This can make small the capacitance of the storage device 5 disposed in the AC motor drive system. Consequently, a further reduction in size or cost of the AC motor drive system can also be made.

If the secondary current amount i2 [A] is used in this way, a charge/discharge current amount, when the chopper circuit is configured in N-multiplex, can correspond to a control signal on a multiple phase basis.

When the multiple chopper circuit is employed and the charge/discharge current amount is caused to correspond to the control signal for each phase, a ripple component of the charge/discharge current can be suppressed, which achieves electric power compensation of good quality and allows for noise reduction. In other words, the number of anti-noise components can be reduced for the AC motor drive system, or the anti-noise components of low quality can be employed. Thus, the AC motor drive system can be fabricated at low price.

In addition, by disposing the storage device voltage value detection means 51 to measure the across-voltage value Vcap [V] of the storage device 5 and then deliver the value to the charge/discharge control means 8, the electric power storage regulation technique, described in Patent Document 1 disclosed in BACKGROUND ART, can also be employed.

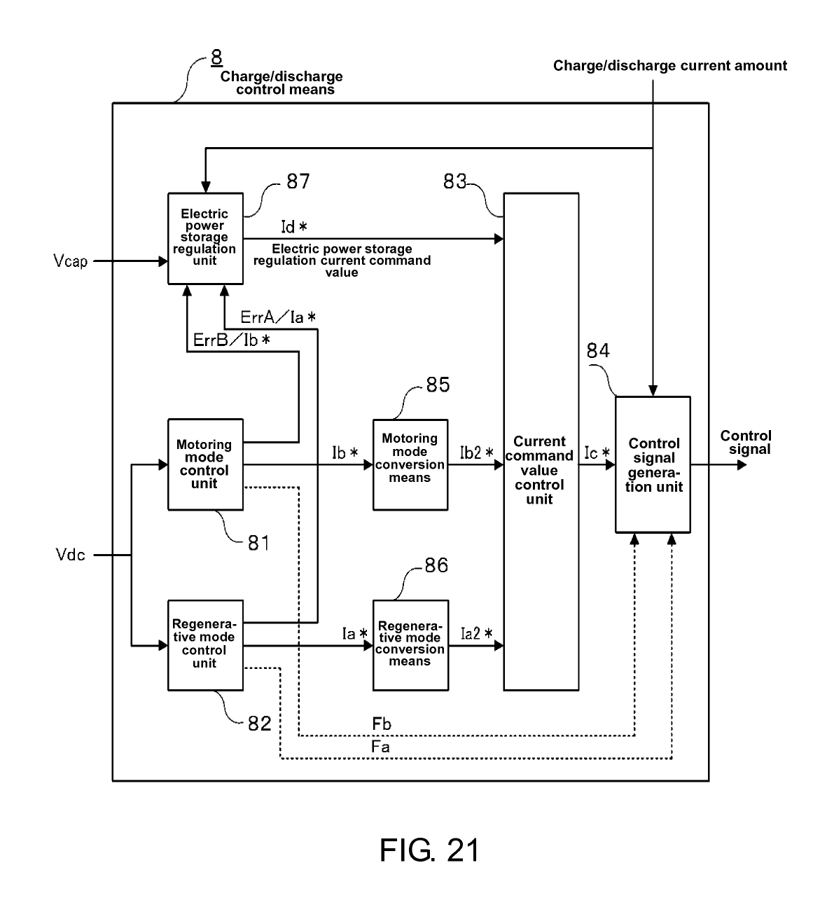

More specifically, an electric power storage regulation unit 87 is further disposed within the charge/discharge control means 8, as shown in FIG. 21. The electric power storage regulation unit 87 receives the across-voltage value Vcap [V], which is the output from the storage device voltage value detection means 51. The electric power storage regulation unit 87 receives the charge/discharge current amount, which is the output from the charge/discharge current amount detection means 64. The storage regulation unit 87 receives ErrB [V] or the discharge current command value Ib* [A], each of which is the output from the motoring mode control unit 81. The storage regulation unit 87 receives ErrA [V] or the charge current command value Ia* [A], each of which is the output from the regenerative mode control unit 82. The storage regulation unit 87 generates, in response to the input thereto, an electric power storage regulation current command value Id* [A] and delivers the generated value to the current command value combination unit 83. The current command value combination unit 83 adds together the electric power storage regulation current command value Id* [A], which is the output from the storage regulation unit 87, the secondary discharge current command value Ib2* [A], which is the output from the motoring mode conversion means 85, and the secondary charge current command value Ia2* [A], which is the output from the regenerative mode conversion means 86, and then generates the combined current command value Ic* [A]. The current command value combination unit 83 delivers the combined current command value Ic* [A] to the control signal generation unit 84.

In the storage regulation unit 87, the configuration of a constant voltage control unit 16E, described in Patent Document 1, is employed. Further, in the storage regulation unit 87, the configuration, as shown in Embodiment 1 through Embodiment 3 of the present invention, is used in which the storage regulation unit operates in response to the voltage value Vdc [A], not to the electric power value of the DC bus 2. In this way, by using the storage adjustment technique described in Patent Document 1, advantageous effects of the technique can be achieved as well.

Here, FIG. 21 shows an instance of incorporating the motoring mode conversion means 85 and the regenerative mode conversion means 86 into the charge/discharge control means 8. However, it does not matter if the storage regulation unit 87 does not incorporate either the motoring mode conversion means 85 or the regenerative mode conversion means 86. And yet, it does not matter if the storage regulation unit 87 does not incorporate both of the motoring conversion means 85 and the regenerative conversion means 86.

### Embodiment 4

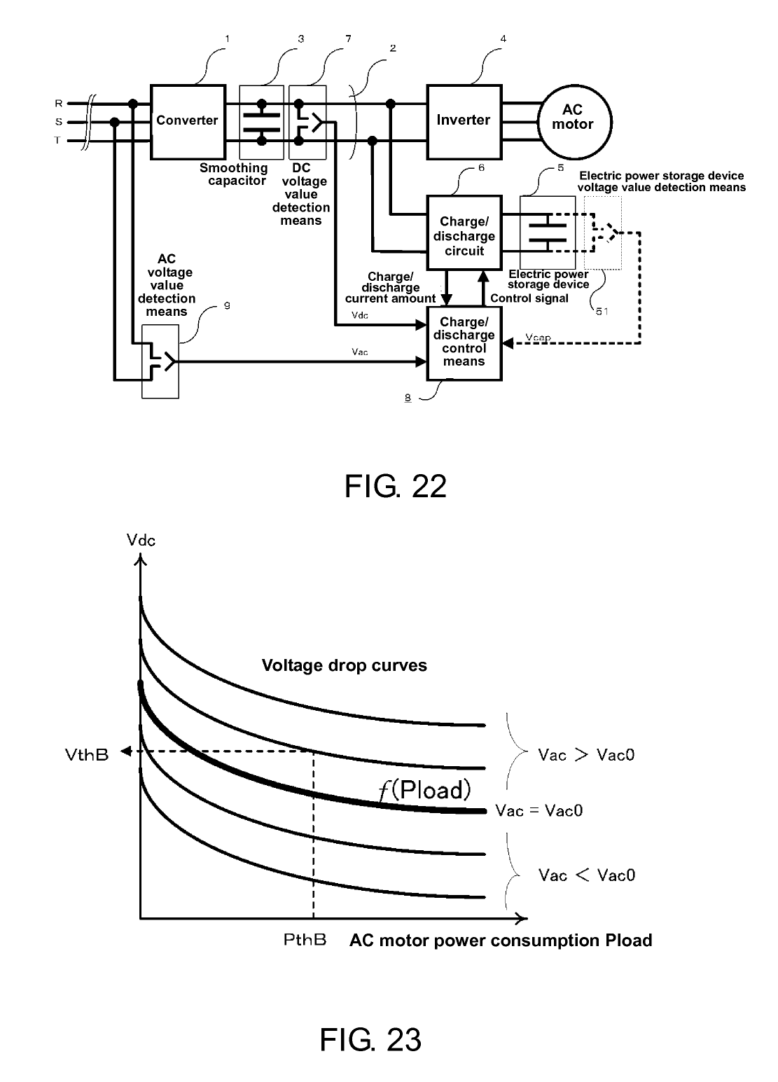

FIG. 22 shows an overall block diagram of an AC motor drive system according to Embodiment 4. The difference between the present embodiment and each of Embodiment 1 (refer to FIG. 1) through Embodiment 3 (refer to FIG. 18) is that an AC voltage value detection means 9 is provided which measures a voltage value Vac [V] between AC lines connected to the input side of the converter 1 (hereinafter called AC line voltage value), to deliver the measured value to the charge/discharge control means 8.

Note that portions shown in dotted lines of FIG. 22 represent a configuration resulting from Embodiment 3 being applied to the present embodiment, and that in the present embodiment, the same or similar means as those in Embodiment 1 through Embodiment 3 are shown by the same designations and symbols, and their descriptions will not be provided herein.

Operating principles of the AC motor drive system according to Embodiment 4 will be described. The AC line voltage value Vac [V] that is received by the converter 1 varies depending on the length of wiring ranging from the AC electric power supply to the converter 1. In addition, when plural AC motor drive systems are connected to one and the same AC electric power supply, the AC line voltage value Vac [V] that is received by the converter 1 in a single AC motor drive system varies depending on fluctuations of operating conditions of the remaining AC motor drive systems. As the AC line voltage value Vac [V] that is received by the converter 1 varies, the DC bus 2 voltage value Vdc [V], which is the output from the converter 1, varies as well.

In the present embodiment, even when the AC line voltage value Vac [V] received by the converter 1 varies, motoring electric power that is to be supplied via the converter 1 from the AC electric power supply, is reduced to the predetermined threshold value PthB [W]. Further, even when the AC line voltage value Vac [V] received by the converter 1 varies, regenerative electric power that is to be regenerated via the converter 1 is retained at the predetermined threshold value PthA [W].

The AC motor drive system according to Embodiment 4 during motoring operation will next be described. When an AC motor performs the motoring operation, relationships between the electric power consumption Pload [W] of the AC motor and the DC bus 2 voltage value Vdc [V] in terms of variations of the AC line voltage value Vac [V], are as shown in FIG. 23. Here, the voltage value Vac0 [V] is a voltage value serving as a reference of the AC line voltage value Vac [V].

When the actual AC line voltage value Vac [V] is greater as compared to the voltage value Vac0 [V] serving as the reference, the voltage drop curve corresponding thereto is substantially translated toward a higher voltage value Vdc [V]. Conversely, when the actual AC line voltage value Vac [V] is smaller than the voltage value Vac0 [V] serving as the reference, the voltage drop curve corresponding thereto is substantially translated toward a lower voltage value Vdc [V].

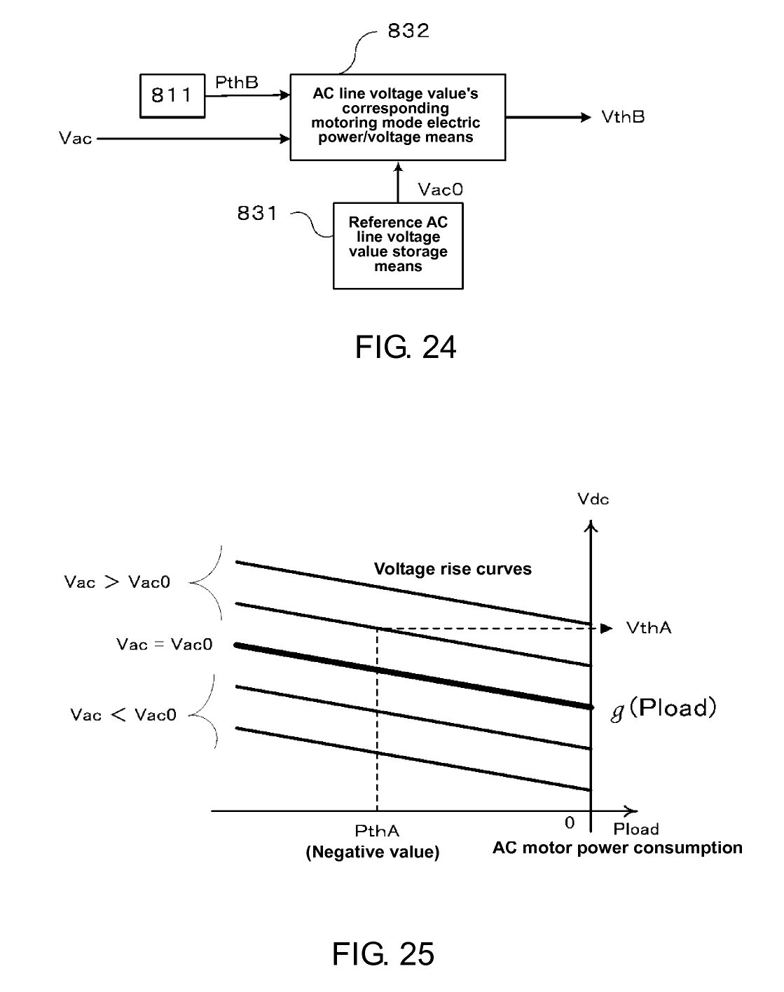

Accordingly, in order to have a configuration for handling the variations of the AC line voltage value Vac [V], the motoring mode control unit 81 according to Embodiment 4 includes reference AC line voltage value storage means 831 where the voltage value Vac0 [V] serving as the reference is pre-recorded, as shown in FIG. 24. The present embodiment further includes AC line voltage value's corresponding motoring mode electric power/voltage means 832 in place of the motoring mode electric power/voltage means 812, described in Embodiment 1 through Embodiment 3, that receives only the threshold value PthB [W]—the output from the motoring mode electric power threshold value storage means 811—and delivers the voltage value VthB [V]. The AC line voltage value's corresponding motoring mode electric power/voltage means 832 contains beforehand voltage drop characteristic curves shown in FIG. 23, by means such as an approximate expression or LUT.

In addition, as with Embodiment 1 through Embodiment 3, the power/voltage means 832 may contain beforehand in the form such as of an approximate expression or LUT a function f(Pload) alone representing values of the voltage drop curve for Vac=Vac0, and perform the calculation of Equation 5 for this function f(Pload) to thereby calculate the voltage value VthB [V]:

VthB=Kb(Vac/Vac0)f(Pload) Equation 5

where Kb (>0) is a constant that is used to adjust a rate at which the voltage drop curve is translated according to the AC line voltage value Vac [V].

The power/voltage means 832 receives the AC line voltage value Vac [V] measured with the AC voltage value detection means 9. The power/voltage means 832 receives the voltage value Vac0 [V] pre-recorded in the reference AC line voltage value storage means 831. The power/voltage means 832 receives the threshold value PthB [W], which is the output from the threshold value storage means 811. The power/voltage means 832 delivers the voltage value VthB [V] in response to the input thereto.

Note that the a destination for delivering the output VthB [V] from the power/voltage means 832 is the same as that of each of Embodiment 1 through Embodiment 3. The power/voltage means 832 delivers the output VthB [V] to the subtraction means 813 or the motoring mode conversion means 85.

The AC motor drive system according to Embodiment 4 during regenerative operation will next be described. When the AC motor performs the regenerative operation, the relationships between the AC motor electric power consumption Pload [W] and the DC bus 2 voltage value Vdc [V] in terms of variations of the AC line voltage value Vac [V], are as shown in FIG. 25.

When the actual AC line voltage value Vac [V] is greater as compared to the voltage value Vac0 [V] serving as the reference, the voltage rise curve corresponding thereto is substantially translated toward a higher voltage value Vdc [V]. Conversely, when the actual AC line voltage value Vac [V] is smaller than the voltage value Vac0 [V] serving as the reference, the voltage rise curve corresponding thereto is substantially translated toward a lower voltage value Vdc [V].

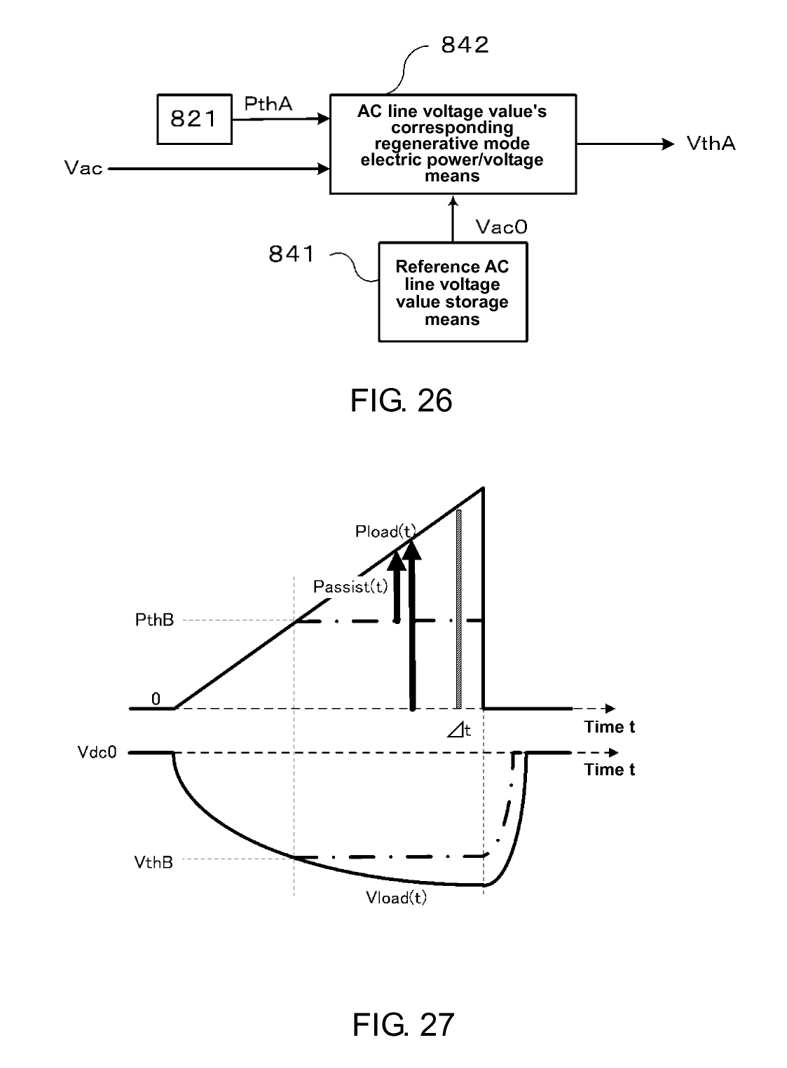

Accordingly, in order to have a configuration for handling the variations of the AC line voltage value Vac [V], the regenerative mode control unit 82 according to Embodiment 4 includes reference AC line voltage value storage means 841 where the voltage value Vac0 [V] serving as the reference is pre-recorded, as shown in FIG. 26. The present embodiment further includes AC line voltage value's corresponding regenerative mode electric power/voltage means 842 in place of the regenerative mode electric power/voltage means 822, described in Embodiment 1 through Embodiment 3, that receives only the threshold value PthA [W]—the output from the regenerative mode electric power threshold value storage means 821—and delivers the voltage value VthA [V]. The AC line voltage value's corresponding regenerative mode electric power/voltage means 842 contains beforehand voltage drop characteristic curve data shown in FIG. 25, by means such as an approximate expression or LUT.

In addition, as with Embodiment 1 through Embodiment 3, the power/voltage means 842 may contain beforehand in the form such as of an approximate expression or LUT a function g(Pload) alone representing values of the voltage drop curve for Vac=Vac0, and perform the calculation of Equation 6 for this function g(Pload) to thereby calculate the voltage value VthA [V]:

VthA=Ka(Vac/Vac0)g(Pload) Equation 6

where Ka (>0) is a constant that is used to adjust a rate at which the voltage rise curve is translated according to the AC line voltage value Vac [V].

The power/voltage means 842 receives the AC line voltage value Vac [V] measured with the AC voltage value detection means 9. The power/voltage means 842 receives the voltage value Vac0 [V] pre-recorded in the reference AC line voltage value storage means 841. The power/voltage means 842 receives the threshold value PthA [W], which is the output from the regenerative mode electric power threshold value storage means 821. The power/voltage means 842 delivers the voltage value VthA [V] in response to the input thereto.

Note that the a destination for delivering the output VthA [V] from the power/voltage means 842 is the same as that of each of Embodiment 1 through Embodiment 3. The power/voltage means 842 delivers the output VthA [V] to the subtraction means 823 or the regenerative mode conversion means 86.

According to the present embodiment, even when the AC line voltage value Vac [V] received by the converter 1 varies, motoring mode electric power that is to be supplied via the converter 1 from the AC electric power supply can be reduced to the predetermined threshold value PthB [W] without providing DC bus current amount detection means. Further, even when the AC line voltage value Vac [V] received by the converter 1 varies, regenerative electric power that is to be regenerated via the converter 1 can be retained at the predetermined threshold value PthA [W] without providing DC bus current amount detection means.

### Embodiment 5

Another embodiment for the motoring mode control unit 81 will be described. Now, consider an instance where in the AC motor drive systems according to Embodiment 1 through Embodiment 4, the AC motor performs the motoring operation of Pload(t) [W]. In this instance, unless electric power Passist(t) [W] exists which is supplied from the electric power storage device 5 via the charge/discharge circuit 6 to the DC bus 2, then the DC bus voltage value Vdc [V] is assumed to be Vload(t) [V] (refer to FIG. 27), where t represents a time.

Next, consider an instance where the electric power Passist(t) [W] exists, and the electric power that is to be supplied from an AC electric power supply is regulated to the threshold value PthB [W]. When energy transfer in a short time interval At is considered in this instance, Equation 7 holds.

Passist(t)Δt=Pload(t)Δt−PthBΔt Equation 7

The DC bus voltage value Vdc [V] represents energy stored in the smoothing capacitor 3. Thus, Equation 7 can be rewritten as Equation 8.

Passist(t)Δt=(½)C[Vdc0²−{Vload(t)}²]−(½)C(Vdc0²−VthB²)=−(½)C[{Vload(t)}²−VthB²] Equation 8

In addition, Vload(t) [V], when electric power is being supplied from the storage device 5, is nothing but the value Vdc [V] measured by the DC voltage value detection means 7. Hence, Equation 8 can be further rewritten as Equation 9.

Passist(t)Δt=−(½)C(Vdc²−VthB²) Equation 9

Hence, based on Equation 9, the difference between the square value of the voltage value Vdc [V] and that of the voltage value VthB [V] is assumed to be ErrB [V], and from a value obtained by multiplying this value ErrB [V] by −(½)C, the discharge current command value Ib* [A] can be generated.

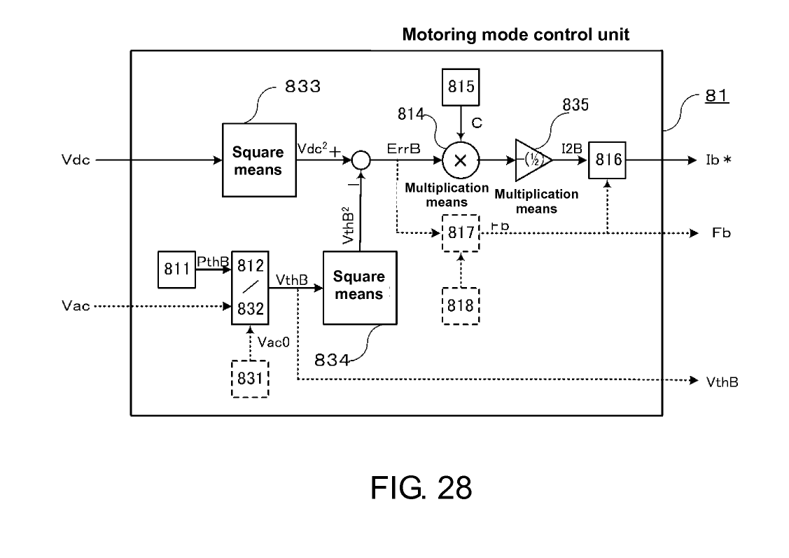

FIG. 28 shows a block diagram of the motoring mode control unit 81 according to Embodiment 5. Note that portions shown in dotted lines of FIG. 28 represent a configuration resulting from Embodiment 2 through Embodiment 4 being applied to the present embodiment. Further, the same or similar means as those in Embodiment 1 through Embodiment 4 are shown by the same designations and symbols, and their descriptions will not be provided herein.

In the drawing, square means 833 receives the voltage value Vdc [V], which is the output from the DC voltage value detection means 7. The square means 833 calculates Vdc² in response to the input thereto and delivers it to a minuend input port of the subtraction means 813.

Square means 834 receives the voltage VthB [V], which is the output from the motoring mode electric power/voltage means 812 or the AC line voltage value's corresponding motoring mode electric power/voltage means 832. The square means 834 calculates VthB² in response to the input thereto and delivers it to a subtrahend input port of the subtraction means 813.

The subtraction means 813 calculates Vdc²−VthB² in response to the input thereto and delivers it as the output ErrB [V] to the multiplication means 814.

The multiplication means 814 calculates C (Vdc²−VthB²) in response to the input thereto and delivers it to multiplication means 835. The multiplication means 835 multiplies C (Vdc²−VthB²), which is the input value, by −(½) and delivers the result to the motoring mode electric power compensation control unit 816 or the motoring mode conversion means 85. In the descriptions to follow, the square means 833, the square means 834, the subtraction means 813, the multiplication means 814 and the multiplication means 835 are collectively treated as motoring mode calculation means.

The motoring mode electric power compensation control unit 816 generates the discharge current command value Ib* [A] in response to the input value thereto, and delivers it to the current command value combination unit 83.

According to the present embodiment, by not using Equation 1 but using even Equation 9, without providing the DC bus current amount detection means, motoring mode electric power that is to be supplied from the AC electric power supply via the converter 1 can be reduced to the predetermined threshold PthB [W].

Here, a configuration of the motoring mode control unit 81 is not limited to the above configuration. For example, in the motoring mode calculation means, the multiplication means 814 and the multiplication means 835 may be combined into single multiplication means, to perform one time multiplication process. In another instance, it will of course be understood that the configuration of the motoring mode calculation means may be such that means including the subtraction means 813, the multiplication means 814 and the multiplication means 835 are disposed in different positions such as those obtained by reversing their order, so long as the calculated result is the same.

In Embodiment 1 through Embodiment 5, it has been described that the motoring mode electric power threshold vale storage means 811 stores the predetermined threshold value PthB [W] of electric power that is to be supplied from the AC electric power supply via the converter 1 to the DC bus 2. It also has been described that the motoring mode electric power/voltage means 812 stores predetermined voltage-drop-characteristic curve data. And it has been described that the smoothing capacitor capacitance value storage means 815, 825 each store the predetermined capacitance value C [F] of the smoothing capacitor 3. It has been described that the third storage means 818 stores a predetermined threshold value that limits an operation of the charge/discharge circuit 6 during motoring operation of the AC motor. It has been described that the regenerative mode electric power threshold value storage means 821 stores a predetermined threshold value PthA [W] of electric power that is regenerated via the converter 1 from the DC bus 2. It has been described that the regenerative mode electric power/voltage means 822 stores predetermined voltage-rise-characteristic curve data. It has been described that the fourth storage means 828 stores a predetermined threshold value that limits an operation of the charge/discharge circuit 6 during regenerative operation of the AC motor. It has been described that the reference AC line voltage value storage means 831, 841 each store a predetermined numeric value of the voltage value Vac( )[V] serving as the reference between AC lines, which is the input side of the converter 1. It has been described that the AC line voltage value's corresponding motoring mode electric power/voltage means 832 stores predetermined voltage-drop-characteristic curve data corresponding to variations of the AC line voltage value. It has been described that the AC line voltage value's corresponding regenerative mode electric power/voltage means 842 stores predetermined voltage-rise-characteristic curve data corresponding to variations of the AC line voltage value. These describe the time when the AC motor drive system starts its operation and the subsequent time.

It may be designed that the above threshold values, numeric values or characteristics can be set up or similar action can be taken, at a time such as before the AC motor drive system starts its operation, i.e., during carrying-in of the system, at completion of a system inspection, at a time before daily start-up of the system, or at a time of task alteration. It will suffice if an action such as this set-up can be taken using set-up means including a dial, selection button, devoted interface, or general-purpose communications interface.

And this set-up means may be configured so as to allow for the set-up according to or in response to, for example, operational load condition, motoring or regenerative continuous condition, AC electric power supply operating condition, operation time zone, environmental condition such as noise, and change of capacitance value due to replacement of the storage device 5. Further, this set-up means can be of a type that allows the above threshold values, numerical values, or characteristics to be set up or altered, or deleted according to circumstances. It is obvious that even by including such set-up means in the system, the advantageous effects that are achieved in the AC motor drive systems according to Embodiment 1 through Embodiment 5 are not affected or reduced.

### REFERENCE NUMERALS

1 Converter
11 Three-phase full-wave rectification circuit
111a Diode
111b Diode
111c Diode
111d Diode
111e Diode
111f Diode
12 Regenerated power dissipating resistor circuit
121 Switching element
122 Resistor
13 Rectification circuit
131a Diode
131b Diode
131c Diode
131d Diode
131e Diode
131f Diode
132a Switching element
132b Switching element
132c Switching element
132d Switching element
132e Switching element
132f Switching element
14 AC reactor
2 DC bus
3 Smoothing capacitor
4 Inverter
5 Electric power storage device
51 Electric power storage device voltage value detection means
6 Charge/discharge circuit
61a Diode
61b Diode
61c Diode
61d Diode
62a Switching element
62b Switching element
62c Switching element
62d Switching element
63a Driver circuit
63b Driver circuit
63c Driver circuit
63d Driver circuit
64 Charge/discharge current amount detection means
65 Reactor
7 DC voltage value detection means
8 Charge/discharge control means
81 Motoring mode control unit
811 Motoring mode electric power threshold value storage means
812 Motoring mode electric power/voltage means
813 Subtraction means
814 Multiplication means
815 Smoothing capacitor capacitance value storage means
816 Motoring mode electric power compensation control unit
817 Motoring comparison means
818 Third storage means
831 Reference AC line voltage value storage means
832 AC line voltage value's corresponding motoring mode electric power/voltage means
833 Square means
834 Square means
835 Multiplication means
82 Regenerative mode control unit
821 Regenerative mode electric power threshold value storage means
822 Regenerative mode electric power/voltage means
823 Subtraction means
824 Multiplication means
825 Smoothing capacitor capacitance value storage means
826 Regenerative mode electric power compensation control unit
827 Regenerative comparison means
828 Fourth storage means
841 Reference AC line voltage value storage means
842 AC line voltage value's corresponding regenerative mode electric power/voltage means
83 Current command value combination unit
84 Control signal generation unit
85 Motoring mode conversion means
86 Regenerative mode conversion means
87 Electric power storage regulation unit
9 AC voltage value detection means

1. An alternating current (AC) motor drive system, comprising:
a converter that supplies direct current (DC) electric power;
an inverter that converts the DC electric power to AC electric power;
a DC bus that connects between the converter and the inverter;
an AC motor that is driven by the AC electric power;
a DC voltage value detection device that measures a voltage value at an output side of the converter;
an electric power storage device to which the DC electric power is charged from the DC bus and from which the charged DC electric power is discharged to the DC bus;
a charge/discharge circuit connected to the DC bus in parallel with the inverter, and connected between the DC bus and the electric power storage device, the charge/discharge circuit causing the electric power storage device to be charged or discharged; and
a charge/discharge current amount detection device that measures an amount of charge/discharge current of the electric power storage device,
wherein according to the DC voltage value measured by the DC voltage value detection device and to the charge/discharge current amount measured by the charge/discharge current amount detection device, the charge/discharge circuit causes the electric power storage device to discharge an amount of electric power, from among amounts of electric power supplied from the inverter to the AC motor, that exceeds a first electric power threshold value, or the circuit causes the electric power storage device to be charged by an amount of electric power, from among amounts of AC motor regenerative electric power regenerated via the inverter, that exceeds a second electric power threshold value.

2. An alternating current (AC) motor drive system, comprising:
a converter that supplies direct current (DC) electric power;
an inverter that converts the DC electric power to AC electric power;
a DC bus that connects between the converter and the inverter;
an AC motor that is driven by the AC electric power;
a DC voltage value detection device that measures a voltage value at an output side of the converter;
an electric power storage device to which the DC electric power is charged from the DC bus and from which the charged DC electric power is discharged to the DC bus;
a charge/discharge circuit connected to the DC bus in parallel with the inverter, and connected between the DC bus and the electric power storage device, the charge/discharge circuit causing the electric power storage device to be charged or discharged; and
a charge/discharge current amount detection device that measures an amount of charge/discharge current of the electric power storage device,
wherein according to the voltage value measured by the DC voltage value detection device and to the charge/discharge current amount measured by the charge/discharge current amount detection device, the charge/discharge circuit causes the electric power storage device to be discharged so that when an amount of electric power supplied from the inverter to the AC motor exceeds the first electric power threshold value, the voltage value measured by the DC voltage value detection device is a first voltage value corresponding to the first electric power threshold value, or the circuit causes the electric power storage device to be charged so that when an amount of regenerative electric power of the AC motor regenerated via the inverter exceeds the second electric power threshold value, the voltage value measured by the DC voltage value detection device is a second voltage value corresponding to the second electric power threshold value.

3. An alternating current (AC) motor drive system, comprising:
a converter that supplies direct current (DC) electric power;
an inverter that converts the DC electric power to AC electric power;
a DC bus that connects between the converter and the inverter;
an AC motor that is driven by the AC electric power;
a DC voltage value detection device that measures a voltage value at an output side of the converter;
an AC voltage value detection device that measures a voltage value at an input side of the converter;
an electric power storage device to which the DC electric power is charged from the DC bus and from which the charged DC electric power is discharged to the DC bus;
a charge/discharge circuit connected to the DC bus in parallel with the inverter, and connected between the DC bus and the electric power storage device, the charge/discharge circuit causing the electric power storage device to be charged or discharged; and
a charge/discharge current amount detection device that measures an amount of charge/discharge current of the electric power storage device,
wherein according to the voltage value measured by the DC voltage value detection device, to the voltage value measured by the AC voltage value detection device, and to the charge/discharge current amount measured by the charge/discharge current amount detection device, the charge/discharge circuit causes the electric power storage device to be discharged so that when an amount of electric power supplied from the inverter to the AC motor exceeds the first electric power threshold value, the voltage value measured by the DC voltage value detection device is a first voltage value corresponding to the first electric power threshold value and the voltage value measured by the AC voltage value detection device, or the circuit causes the electric power storage device to be charged so that when an amount of regenerative electric power of the AC motor regenerated via the inverter exceeds the second electric power threshold value, the voltage value measured by the DC voltage value detection device is a second voltage value corresponding to the second electric power threshold value and the voltage value measured by the AC voltage value detection device.

4. An alternating current (AC) motor drive system, comprising:
a converter that supplies direct current (DC) electric power;
an inverter that converts the DC electric power to AC electric power;
a DC bus that connects between the converter and the inverter;
an AC motor that is driven by the AC electric power;
a DC voltage value detection device that measures a voltage value at an output side of the converter;
an electric power storage device to which the DC electric power is charged from the DC bus and from which the charged DC electric power is discharged to the DC bus;
an electric power storage device voltage value detection device that measures a voltage value across the electric power storage device;
a charge/discharge circuit connected to the DC bus in parallel with the inverter, and connected between the DC bus and the electric power storage device, the charge/discharge circuit causing the electric power storage device to be charged or discharged; and
a charge/discharge current amount detection device that measures an amount of charge/discharge current of the electric power storage device,
wherein according to the voltage value measured by the DC voltage value detection device, to the voltage value measured by the electric power storage device voltage value detection device, and to the charge/discharge current amount measured by the charge/discharge current amount detection device, the charge/discharge circuit causes the electric power storage device to be discharged using a discharge current of the charge/discharge circuit corresponding to the voltage value measured by the electric power storage device voltage value detection device so that when an amount of electric power supplied from the inverter to the AC motor exceeds the first electric power threshold value, the voltage value measured by the DC voltage value detection device is a first voltage value corresponding to the first electric power threshold value, or the circuit causes the electric power storage device to be charged using a charge current of the charge/discharge circuit corresponding to the voltage value measured by the electric power storage device voltage value detection device so that when an amount of regenerative electric power of the AC motor regenerated via the inverter exceeds the second electric power threshold value, the voltage value measured by the DC voltage value detection device is a second voltage value corresponding to the second electric power threshold value.

5. An alternating current (AC) motor drive system, comprising:
a converter that supplies direct current (DC) electric power;
an inverter that converts the DC electric power to AC electric power;
a DC bus that connects between the converter and the inverter;
an AC motor that is driven by the AC electric power;
a DC voltage value detection device that measures a voltage value at an output side of the converter;
an AC voltage value detection device that measures a voltage value at an input side of the converter;
an electric power storage device to which the DC electric power is charged from the DC bus and from which the charged DC electric power is discharged to the DC bus;
an electric power storage device voltage value detection device that measures a voltage value across the electric power storage device;
a charge/discharge circuit connected to the DC bus in parallel with the inverter, and connected between the DC bus and the electric power storage device, the charge/discharge circuit causing the electric power storage device to be charged or discharged; and
a charge/discharge current amount detection device that measures an amount of charge/discharge current of the electric power storage device,
wherein according to the voltage value measured by the DC voltage value detection device, to the voltage value measured by the AC voltage value detection device, to the voltage value measured by the electric power storage device value detection device, and to the charge/discharge current amount measured by the charge/discharge current amount detection device, the charge/discharge circuit causes the electric power storage device to be discharged using a discharge current of the charge/discharge circuit corresponding to a voltage value measured by the electric power storage device voltage value detection device so that when an amount of electric power supplied from the inverter to the AC motor exceeds the first electric power threshold value, the voltage value measured by the DC voltage value detection device is a first voltage value corresponding to the first electric power threshold value and the voltage value measured by the AC voltage value detection device, or the circuit causes the electric power storage device to be charged using a charge current of the charge/discharge circuit corresponding to a voltage value measured by the electric power storage device voltage value detection device so that when an amount of regenerative electric power of the AC motor regenerated via the inverter exceeds the second electric power threshold value, the voltage value measured by the DC voltage value detection device is a second voltage value corresponding to the second electric power threshold value and the voltage value measured by the AC voltage value detection device.
